(19) United States
(12) Patent Application Publication
(10) Pub. No.: US 2011/0164203 A1
(43) Pub. Date: Jul. 7, 2011

(54) SURFACE LIGHT SOURCE AND LIQUID CRYSTAL DISPLAY APPARATUS

(75) Inventor: Syunsuke Kimura, Hyogo (JP)

(73) Assignee: PANASONIC CORPORATION, Kadoma-shi, Osaka (JP)

(21) Appl. No.: 13/062,404

(22) PCT Filed: Jun. 21, 2010
(86) PCT No.: PCT/JP2010/004132

§ 371 Date: Mar. 4, 2011

(30) Foreign Application Priority Data
Jun. 22, 2009 (JP) 2009-147413
Jun. 22, 2009 (JP) 2009-147414

(51) Int. Cl. G02F 1/13357; F21V 9/16

(52) U.S. Cl. 349/62; 362/84

(57) ABSTRACT

A surface light source (1A) includes: a plurality of light emitting elements (10) that emit a first colored light; a first reflecting member (20) disposed behind the light emitting elements; a diffusing member (30) disposed in front of the light emitting elements; and a second reflecting member (50) disposed in front of the diffusing member. A phosphor layer (40) for allowing a part of the first colored light to pass through it and converting another part of the first colored light into a second colored light is disposed between the first reflecting member and the second reflecting member. The phosphor layer is configured so that the fraction of the first colored light converted into the second colored light per unit area by the phosphor layer decreases as a distance from an optical axis of each of the light emitting elements increases.

### TECHNICAL FIELD

The present invention relates to a surface light source used, for example, as a backlight of a liquid crystal display apparatus, and to a liquid crystal display apparatus including the surface light source. The present invention relates particularly to a surface light source with reduced color unevenness and a liquid crystal display apparatus.

### BACKGROUND ART

Conventional backlights of liquid crystal display apparatuses are configured to use cold cathode tubes as light sources together with members such as a diffusing plate and a reflecting plate. In recent years, light emitting diodes (hereinafter referred to as “LEDs”) have been used as light sources for these backlights. LEDs have increased their efficiency recently, and are expected to serve as low-power light sources to replace cold cathode tubes. In a direct-type backlight in which a two-dimensional planar array of LEDs is disposed behind a liquid crystal panel, the power consumption of a liquid crystal display apparatus can be reduced or the contrast of the image can be enhanced by controlling the state of brightness (bright or dark state) of each LED locally in the plane for an image to be displayed.

A white surface light source used as a backlight is constructed by using LEDs in the following manner. In one method, for example, a plurality of LEDs of three colors (R (red), G (green), and B (blue) LEDs) are arranged so that the three color lights are mixed to obtain a white color. In another method, a plurality of white light sources are provided. In each of the white light sources, a phosphor is disposed immediately above a monochromatic LED and light from the LED and light generated by the phosphor are mixed to obtain a white color. The method using the phosphor has advantages of being less susceptible to temporal changes in chromaticity and having a relatively high light emitting efficiency.

The chromaticity of a white light source composed of an LED and a phosphor varies depending on the thickness and concentration of the phosphor. Therefore, each white light source is required to have the same chromaticity. However, since the process of applying the phosphor varies, it is difficult to obtain the same chromaticity. As a result, such an application process causes color unevenness of the surface light source.

As a measure against the above-mentioned color unevenness, there is a known method in which light from LEDs is distributed uniformly and then a sheet of phosphor is irradiated with the light to obtain uniform white light. For example, in the method disclosed in Patent Literature 1, light from blue LEDs first is allowed to enter a light guide plate through the end surface thereof and then the blue light is allowed to exit the light guide plate through the main surface thereof. A phosphor sheet that is excited by the light from the blue LEDs to emit yellow light is disposed on the main surface of the light guide plate. The yellow light generated by the phosphor and the blue light that has passed directly through the phosphor sheet are mixed, and thereby, a white surface light source is obtained.

### CITATION LIST

### Patent Literature

[Patent Literature 1] JP 3116727 B2

### SUMMARY OF INVENTION

### Technical Problem

To obtain a surface light source for a large screen liquid crystal display apparatus, it is necessary to ensure a sufficient amount of light. In the method in which light from light sources is allowed to enter the light guide plate through the end surface thereof, the light sources can be placed only in a limited space, and they are placed closely to each other. Furthermore, it is necessary to increase the emission intensity of each light source to ensure the sufficient amount of light, which causes another problem of requiring measures against heat. Moreover, the local control as mentioned above cannot be achieved.

In contrast, in a direct-type backlight having a larger space for placing light sources and being suitable for a large screen liquid crystal display apparatus, it is conceivable to place a phosphor sheet on the light exit surface of a surface light source used as the backlight. For example, it is conceivable to dispose a planar array of blue LEDs as light sources and place a phosphor sheet that is excited by the light from the blue LEDs to emit yellow light on the light exit surface of a surface light source. In general, however, a luminance enhancing sheet such as a prism sheet is used in a surface light source to enhance the luminance in the front direction of the screen of a liquid crystal display apparatus. Therefore, if such a phosphor sheet is disposed on the light emitting side of the luminance enhancing sheet, there occurs a problem that the chromaticity of the surface light source varies with the direction of observing the surface light source. If the phosphor sheet is disposed on the back side of the luminance enhancing sheet, there occurs a problem that the chromaticity changes concentrically with distance from the position of the LED as the center of the concentric circles.

As a result of intensive studies, the present inventor has found out that this concentric change in chromaticity is attributed to the following reasons.

Light emitted from each of the LEDs is multiply reflected repeatedly between the luminance enhancing sheet and a white reflecting plate disposed behind the LEDs. When the phosphor sheet is disposed therebetween, it absorbs the blue light of the LEDs each time the light beam passes through the phosphor sheet. Therefore, the blue light decreases as it is diffused and a distance from the LED increases. However, the phosphor sheet does not absorb the yellow light emitted therefrom even if it enters the phosphor sheet again, and thus the yellow light does not decrease with distance from the LED as much as the blue light. Therefore, the chromaticity of the surface light source takes on a yellow tinge as the distance from the LED increases.

This phenomenon is described in more detail with reference to FIG. 21 to FIG. 23C.

FIG. 21 is a schematic cross-sectional view of a conventionally configured surface light source 100. The surface light source 100 includes blue LEDs 110, a reflecting plate 200, a diffusion sheet 300, a phosphor sheet 400, and a luminance enhancing sheet 500.

The blue LEDs 110 emit blue light. Equally spaced blue LEDs 110 are arranged in a matrix on the front surface of the reflecting plate 200.

The reflecting plate 200 is disposed behind the blue LEDs 110. The reflecting plate 200 has a white diffuse-reflection surface on its front surface, and diffusely reflects the light that reaches the diffuse-reflection surface.

The diffusion sheet 300 is disposed in front of the blue LEDs 110. The diffusion sheet 300 diffuses the light that enters the diffusion sheet 300 through its back surface. A part of the diffused light passes through the diffusion sheet 300 and is emitted from the front surface of the diffusion sheet 300. Another part of the diffused light returns in the back direction (to the side of the blue LEDs 110) by reflection.

The phosphor sheet 400 is disposed between the diffusion sheet 300 and the luminance enhancing sheet 500 described below. The phosphor sheet 400 contains a phosphor (not shown). When this phosphor is exposed to blue light, it is excited to emit yellow light. The phosphor sheet 400 allows a part of the blue light that enters the phosphor sheet 400 through its back surface to directly pass through, and converts another part of the blue light into yellow light by the wavelength converting action of the phosphor and allows the yellow light to pass through. The blue light and the yellow light are mixed to form white light.

The luminance enhancing sheet 500 is disposed in front of the diffusion sheet 300. The luminance enhancing sheet 500 reflects back a part of the light that reaches its back surface. The luminance enhancing sheet 500 allows another part of the light to pass through and emits the light in such a way that the light is focused in the normal direction to its light exit surface. Thus, the front luminance of the emitted light is enhanced.

Next, the action of the surface light source 100 is described with reference to FIG. 22A to FIG. 22C and FIG. 23A to FIG. 23C. FIG. 22A to FIG. 22C are diagrams illustrating the states of blue light in the surface light source 100, and FIG. 23A to FIG. 23C are diagrams illustrating the states of yellow light in the surface light source 100. In these diagrams, the directions and widths of arrows schematically indicate the directions and intensities of light beams respectively.

FIG. 22A shows the states of blue light from its emission from the blue LED 110 to its exit from the front surface of the luminance enhancing sheet 500. First, a blue light 20Ba emitted from the blue LED 110 reaches the diffusion sheet 300. The blue light 20Ba that has entered the diffusion sheet 300 is diffused, and a part of the light passes through the diffusion sheet 300 and another part thereof is reflected therefrom. Therefore, the intensity of a blue light 30Ba that has passed through the diffusion sheet 300 is lower than that of the blue light 20Ba. The blue light 30Ba that has passed through the diffusion sheet 300 reaches the phosphor sheet 400. In the phosphor sheet 400, a part of the blue light 30Ba strikes the phosphor (not shown) to excite the phosphor. Another part of the blue light 30Ba passes through the phosphor sheet 400 without striking the phosphor. Therefore, the intensity of a blue light 40Ba that has passed through the phosphor sheet 400 is lower than that of the blue light 30Ba. The blue light 40Ba that has passed through the phosphor sheet 400 reaches the luminance enhancing sheet 500. A part of the blue light 40Ba is reflected from the luminance enhancing sheet 500 and another part thereof passes through it depending on its incident angle to the luminance enhancing sheet 500. The blue light 50Ba that has passed through the luminance enhancing sheet 500 is emitted as the output of the surface light source 100.

FIG. 22B shows the states of the blue light 40Ba in FIG. 22A from its reflection from the luminance enhancing sheet 500 to its arrival at the reflecting plate 200. First, a blue light 40Bb reflected from the luminance enhancing sheet 500 reaches the phosphor sheet 400. In the phosphor sheet 400, a part of the blue light 40Bb strikes the phosphor (not shown) to excite the phosphor. Another part of the blue light 40Bb passes through the phosphor sheet 400 without striking the phosphor. Therefore, the intensity of a blue light 30Bb that has passed through the phosphor sheet 400 is lower than that of the blue light 40Bb. The blue light 30Bb that has passed through the phosphor sheet 400 reaches the diffusion sheet 300. The blue light 30Bb that has entered the diffusion sheet 300 is diffused, and a part of the light passes through the diffusion sheet 300 and another part thereof is reflected therefrom. Therefore, the intensity of a blue light 20Bb that has passed through the diffusion sheet 300 is lower than that of the blue light 30Bb. The blue light 20Bb that has passed through the diffusion sheet 300 reaches the reflecting plate 200. The blue light 20Bb is diffusely reflected from the reflecting plate 200 and again is incident on the diffusion sheet 300.

FIG. 22C shows the states of the blue light 20Bb in FIG. 22B from its reflection from the reflecting plate 200 to its exit from the front surface of the luminance enhancing sheet 500. In this case, the blue lights 20Bc to 50Bc act in the same manner as the above-mentioned blue lights 20Ba to 50Ba in FIG. 22A.

The blue light emitted from the blue LED 110 travels back and forth in the surface light source 100 in the manner as described above. However, since the blue light is output gradually to the outside of the surface light source 100 from the front surface of the luminance enhancing sheet 500, the intensity of the blue light is attenuated accordingly. The blue light also is diffused by each constituent member while its intensity is attenuated. Therefore, the blue light moves further away from the blue LED 110 as it travels back and forth in the surface light source 100. Furthermore, the blue light passes through the phosphor sheet 400 each time it travels in the surface light source 100. Therefore, a part of the blue light strikes the phosphor each time it passes through the phosphor sheet 400, and the intensity of the blue light is attenuated accordingly.

Next, the yellow light emitted from the phosphor sheet 400 is described.

FIG. 23A shows the states of yellow light from its emission from the phosphor sheet 400 to its exit from the front surface of the luminance enhancing sheet 500. First, a yellow light 40Ya emitted from the phosphor sheet 400 reaches the luminance enhancing sheet 500. A part of the yellow light 40Ya is reflected from the luminance enhancing sheet 500 and another part thereof passes through it depending on its incident angle to the luminance enhancing sheet 500. The yellow light 50Ya that has passed through the luminance enhancing sheet 500 is emitted as the output of the surface light source 100.

FIG. 23B shows the states of the yellow light 40Ya in FIG. 23A from its reflection from the luminance enhancing sheet 500 to its arrival at the reflecting plate 200. First, a yellow light 40Yb reflected from the luminance enhancing sheet 500 reaches the phosphor sheet 400. In the phosphor sheet 400, the yellow light 40Yb is not subjected to wavelength conversion. Therefore, a part of the yellow light 40Yb is reflected from the phosphor sheet 400 and another part thereof passes through the phosphor sheet 400 while being diffused therein. Furthermore, in the phosphor sheet 400, a part of the blue light 40Bb in FIG. 22B excites the phosphor and thus a new yellow light is generated. Therefore, a yellow light 30Yb that has passed through the phosphor sheet 400 has approximately the same intensity as or a higher intensity than the yellow light 40Yb. The intensity of the yellow light 30Yb may be lower than that of the yellow light 40Yb due to the degree of reflection from the phosphor sheet 400. However, even if the intensity decreases from the yellow light 40Yb to the yellow light 30Yb, the degree of this decrease is less than the degree of decrease in the intensity from the blue light 40Bb to the blue light 30Bb in FIG. 22B. The yellow light 30Yb that has passed through the phosphor sheet 400 reaches the diffusion sheet 300. The yellow light 30Yb that has entered the diffusion sheet 300 is diffused, and a part of the light passes through the diffusion sheet 300 and another part thereof is reflected therefrom. Therefore, the intensity of a yellow light 20Yb that has passed through the diffusion sheet 300 is lower than that of the yellow light 30Yb. The yellow light 20Yb that has passed through the diffusion sheet 300 reaches the reflecting plate 200. The yellow light 20Yb is diffusely reflected from the reflecting plate 200 and again is incident on the diffusion sheet 300.

FIG. 23C shows the states of the yellow light 20Yb in FIG. 23B from its reflection from the reflecting plate 200 to its exit from the front surface of the luminance enhancing sheet 500. First, a yellow light 20Yc reflected from the reflecting plate 200 reaches the diffusion sheet 300. The yellow light 20Yc that has entered the diffusion sheet 300 is diffused, and a part of the light passes through the diffusion sheet 300 and another part thereof is reflected therefrom. Therefore, the intensity of a yellow light 30Yc that has passed through the diffusion sheet 300 is lower than that of the yellow light 20Yc. The yellow light 30Yc that has passed through the diffusion sheet 300 reaches the phosphor sheet 400. In the phosphor sheet 400, the yellow light 30Yc is not subjected to wavelength conversion. Therefore, a part of the yellow light 30Yc is reflected from the phosphor sheet 400 and another part thereof passes through the phosphor sheet 400 while being diffused therein. Furthermore, in the phosphor sheet 400, a part of the blue light 30Bc in FIG. 22C excites the phosphor and thus a new yellow light is generated. Therefore, a yellow light 40Yc that has passed through the phosphor sheet 400 has approximately the same intensity as or a higher intensity than the yellow light 30Yc. The intensity of the yellow light 40Yc may be lower than that of the yellow light 30Yc due to the degree of reflection from the phosphor sheet 400. However, even if the intensity decreases from the yellow light 30Yc to the yellow light 40Yc, the degree of this decrease is less than the degree of decrease in the intensity from the blue light 30Bc to the blue light 40Bc in FIG. 22C. Subsequently, the yellow lights 40Yc and 50Yc act in the same manner as the above-mentioned yellow lights 40Ya and 50Ya in FIG. 23A.

The yellow light generated in the phosphor sheet 400 travels back and forth in the surface light source 100 in the manner as described above. However, since the yellow light is output gradually to the outside of the surface light source 100 from the front surface of the luminance enhancing sheet 500, the intensity of the yellow light is attenuated accordingly. The yellow light also is diffused by each constituent member while its intensity is attenuated. Therefore, the yellow light moves further away from the blue LED 110 as it travels back and forth in the surface light source 100.

The degree of attenuation of the blue light emitted from the blue LED 110 is different from that of the yellow light emitted from the phosphor sheet 400. More specifically, the intensity of the blue light emitted from the blue LED 110 decreases each time the blue light passes through the phosphor sheet 400 while traveling back and forth in the surface light source 100. In contrast, the intensity of the yellow light emitted from the phosphor sheet 400 remains almost unchanged even after it passes through the phosphor sheet 400 while traveling back and forth in the surface light source 100. This means that the degree of attenuation of the intensity of the blue light is different from that of the yellow light when their intensities are attenuated as the distance from the blue LED 110 increases. In other words, the ratio between the blue light 50Ba emitted from the luminance enhancing sheet 500 in FIG. 22A and the yellow light 50Ya emitted from the luminance enhancing sheet 500 in FIG. 23A is different from the ratio between the blue light 50Bc emitted from the luminance enhancing sheet 500 in FIG. 22C and the yellow light 50Yc emitted from the luminance enhancing sheet 500 in FIG. 23C. Specifically, the yellow light is less attenuated than the blue light. For this reason, even if the amount of the blue light and the amount of the yellow light are adjusted to obtain a desired white color at the position of the blue LED 110, the blue component is attenuated, which forms a more yellowish color as the distance from the blue LED 110 increases. Thus, color unevenness occurs.

The present invention has been made in view of the above problem, and it is an object of the present invention to provide a direct-type surface light source with less color unevenness and a liquid crystal display apparatus including the surface light source.

### Solution to Problem

The surface light source of the present invention includes: a plurality of light emitting elements that emit a first colored light; a first reflecting member, disposed behind the light emitting elements, for reflecting light that reaches its front surface facing the light emitting elements; a diffusing member, disposed in front of the light emitting elements, for diffusing light that enters the diffusing member and emitting the diffused light; a second reflecting member, disposed in front of the diffusing member, for allowing light that reaches its back surface facing the diffusing member to pass through the second reflecting member while reflecting a part of the light; and a phosphor layer, disposed between the first reflecting member and the second reflecting member, for allowing a part of the first colored light to pass through the phosphor layer and converting another part of the first colored light into a second colored light. The phosphor layer is configured so that the fraction of the first colored light converted into the second colored light per unit area by the phosphor layer decreases as a distance from an optical axis of each of the light emitting elements increases.

The liquid crystal display apparatus of the present invention includes: the surface light source; and a liquid crystal panel that is irradiated from behind with light emitted from the surface light source and displays an image.

### ADVANTAGEOUS EFFECTS OF INVENTION

The surface light source of the present invention can provide a direct-type surface light source with less color unevenness. The liquid crystal display apparatus of the present invention can provide a liquid crystal display apparatus with less color unevenness.

### BRIEF DESCRIPTION OF DRAWINGS

FIG. 1 is a schematic perspective view showing a structure of a surface light source according to a first embodiment of the present invention.

FIG. 2 is a schematic cross-sectional view of the surface light source shown in FIG. 1.

FIG. 3 is a diagram illustrating reflections of blue light emitted from one of blue LEDs in the surface light source shown in FIG. 1.

FIG. 4 is a diagram illustrating reflections of yellow light in the surface light source shown in FIG. 1.

FIG. 5 is a diagram showing intensity distributions of lights on a light exit surface of a luminance enhancing sheet. The lights originate from light emitted in the optical axis direction from one of the blue LEDs.

FIG. 6 is a diagram illustrating the states of blue lights emitted at various angles from one of the blue LEDs in the surface light source shown in FIG. 1.

FIG. 7 is a diagram showing intensity distributions of lights on the light exit surface of the luminance enhancing sheet. The lights originate from lights emitted from one of the blue LEDs and are emitted primarily from the luminance enhancing sheet.

FIG. 8A is a diagram showing a modified sheet constituting a phosphor layer, and FIG. 8B is a diagram showing another modified sheet constituting the phosphor layer.

FIG. 9 is a schematic cross-sectional view of a surface light source according to a second embodiment of the present invention.

FIG. 10 is a front view of a phosphor layer.

FIG. 11 is a diagram illustrating reflections of blue light emitted from one of blue LEDs in the surface light source shown in FIG. 9.

FIG. 12 is a diagram illustrating reflections of yellow light in the surface light source shown in FIG. 9.

FIG. 13 is a diagram showing intensity distributions of lights on a light exit surface of a luminance enhancing sheet. The lights originate from light emitted in the optical axis direction from one of the blue LEDs.

FIG. 14 is a diagram illustrating the states of blue lights emitted at various angles from one of the blue LEDs in the surface light source shown in FIG. 9.

FIG. 15 is a diagram showing intensity distributions of lights on the light exit surface of the luminance enhancing sheet. The lights originate from lights emitted from one of the blue LEDs and are emitted primarily from the luminance enhancing sheet.

FIG. 16 is a schematic cross-sectional view of a modified surface light source in the second embodiment.

FIG. 17 is a schematic cross-sectional view of another modified surface light source in the second embodiment.

FIG. 18 is a schematic perspective view showing a structure of a liquid crystal display apparatus including the surface light source according to the first embodiment.

FIG. 19 is a schematic cross-sectional view of the liquid crystal display apparatus shown in FIG. 18.

FIG. 20 is a schematic cross-sectional view of a liquid crystal display apparatus including the surface light source according to the second embodiment instead of the surface light source according to the first embodiment.

FIG. 21 is a schematic cross-sectional view of a conventional surface light source.

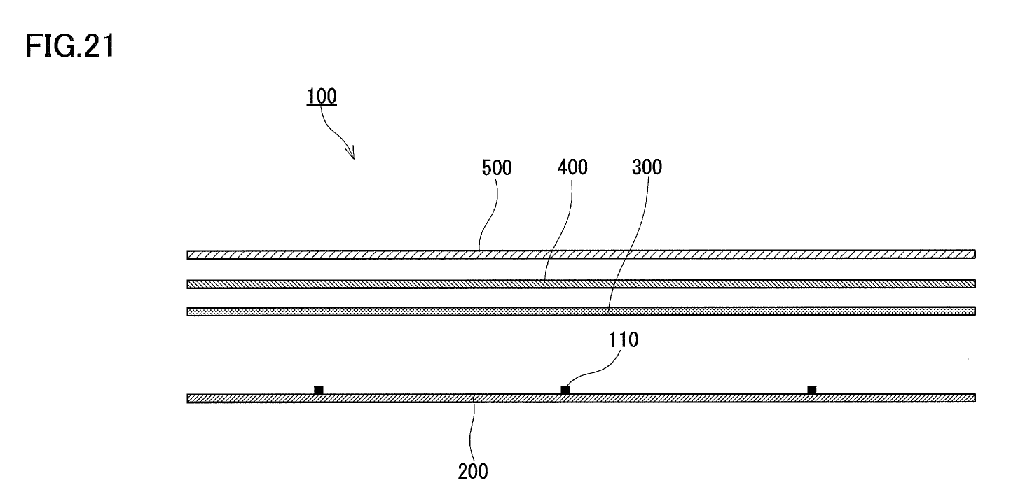

FIG. 22A is a diagram illustrating the states of blue light from its emission from a blue LED to its exit from a front surface of a luminance enhancing sheet in the conventional surface light source, FIG. 22B is a diagram illustrating the states of blue light from its reflection from the luminance enhancing sheet to its arrival at a reflecting plate, and FIG. 22C is a diagram illustrating the states of blue light from its reflection from the reflecting plate to its exit from the front surface of the luminance enhancing sheet.

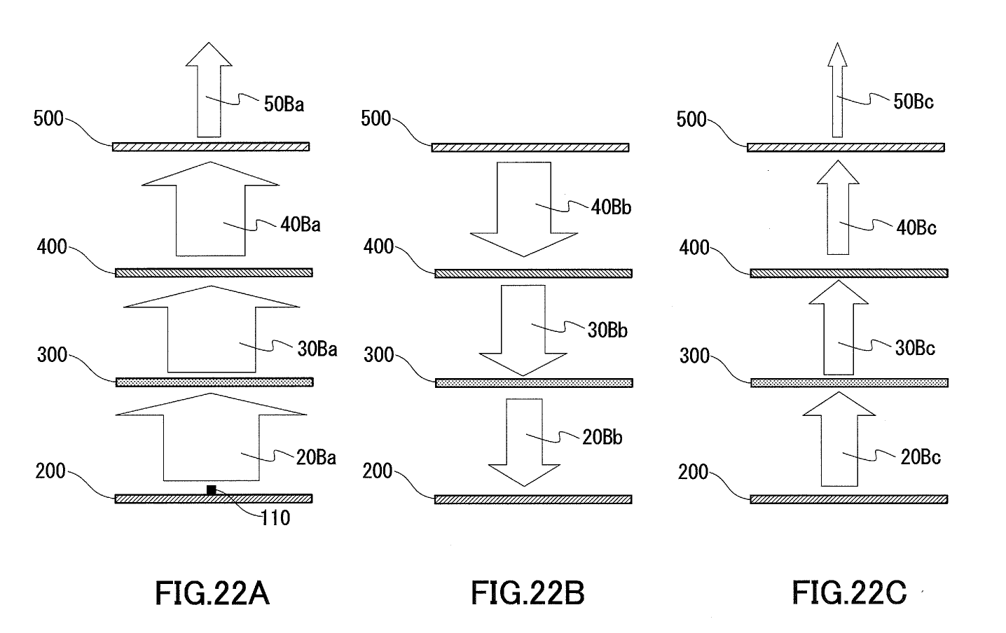

FIG. 23A is a diagram illustrating the states of yellow light from its emission from a phosphor sheet to its exit from the front surface of the luminance enhancing sheet in the conventional surface light source, FIG. 23B is a diagram illustrating the states of yellow light from its reflection from the luminance enhancing sheet to its arrival at the reflecting plate, and FIG. 23C is a diagram illustrating the states of yellow light from its reflection from the reflecting plate to its exit from the front surface of the luminance enhancing sheet.

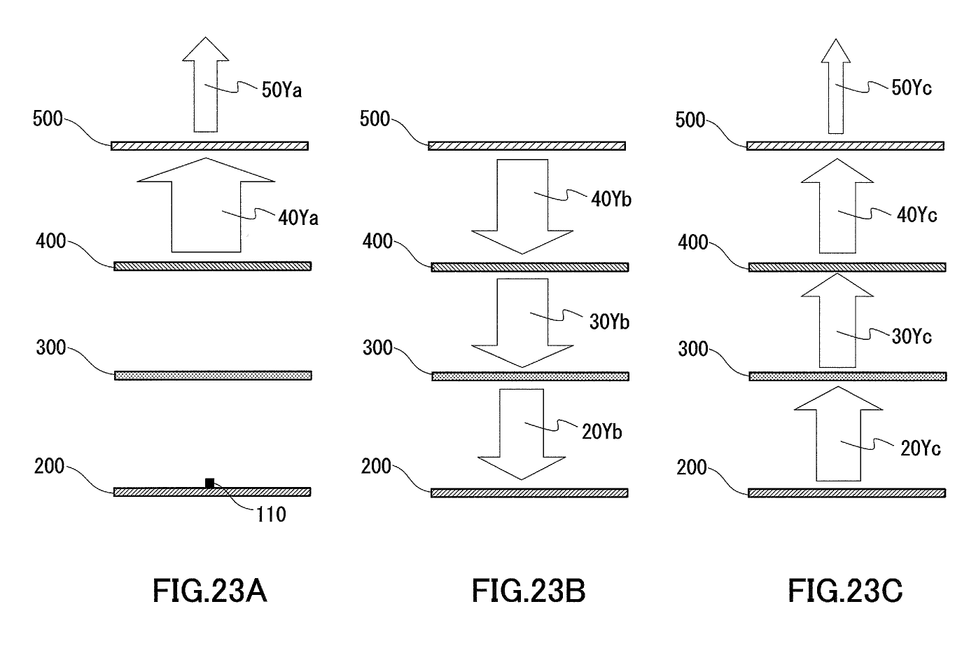

### DESCRIPTION OF EMBODIMENTS

Hereinafter, embodiments of the present invention will be described with reference to the accompanying drawings. In the following embodiments, the similar constituent elements are denoted by the same reference numerals, and the description thereof may be omitted.

<Surface Light Source>

### First Embodiment

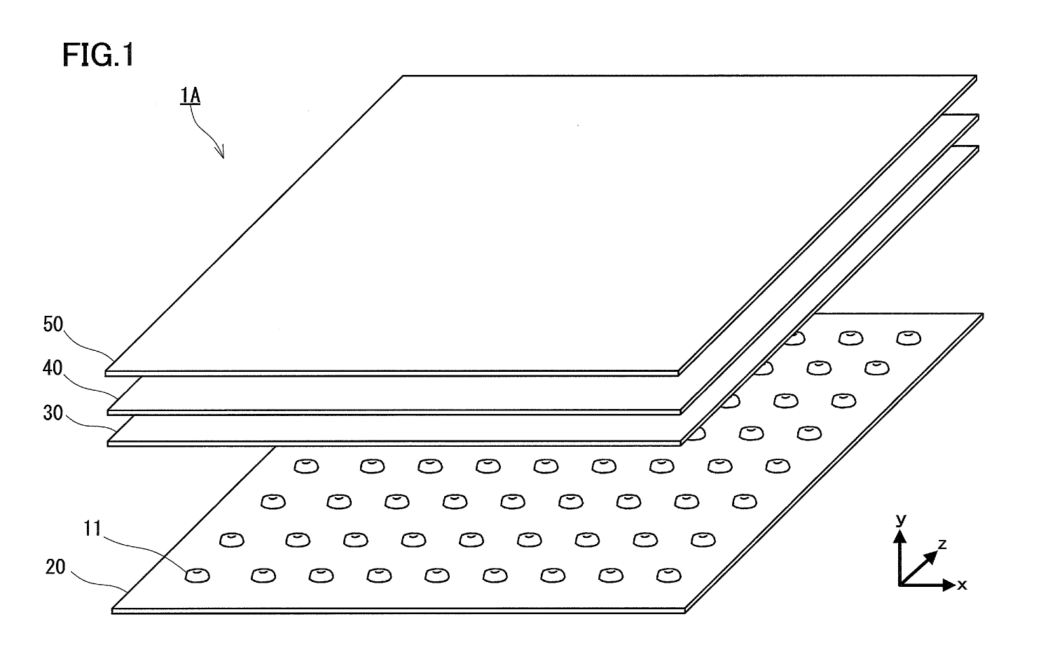

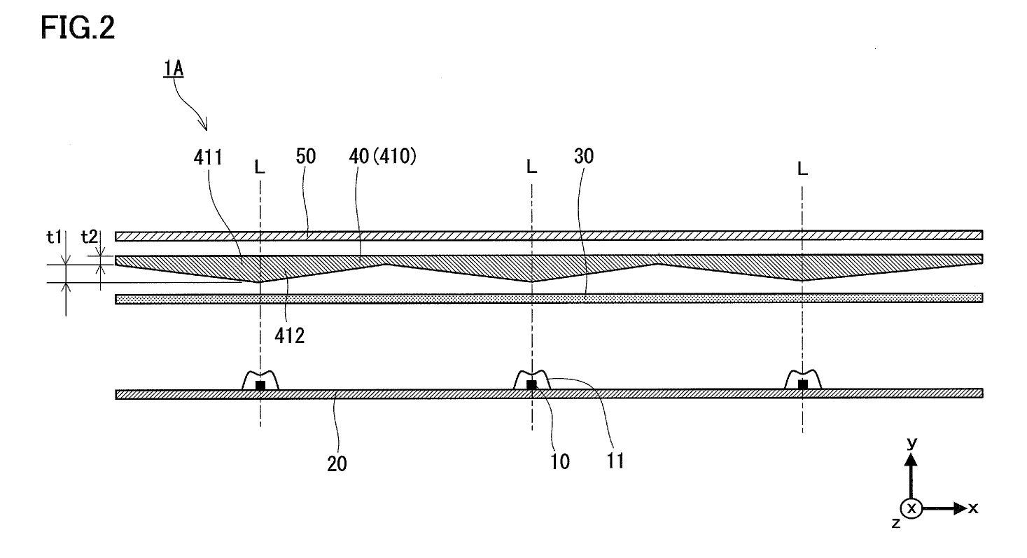

FIG. 1 is a schematic perspective view showing the structure of a surface light source 1A according to the first embodiment. FIG. 2 is a schematic cross-sectional view of the surface light source 1A taken along the x-y plane including the optical axis of a blue LED 10. FIG. 1 and FIG. 2 each show only the characteristic parts of the present embodiment, and other parts are partially omitted. As stated herein, the direction of the x axis is referred to as a “lateral direction” or a “horizontal direction”, the positive direction of the y axis, which is the direction in which the surface light source 1A emits light, is referred to as a “forward direction” or a “front direction”, the negative direction of the y axis is referred to as a “backward direction” or a “back direction”, the positive direction of the z axis is referred to as an “upward direction”, and the negative direction of the z axis is referred to as a “downward direction”. In each of the constituent elements, a surface facing in the front direction is referred to as a “forward surface” or a “front surface”.

The surface light source 1A includes blue LEDs 10, a reflecting plate 20, a diffusion sheet 30, a phosphor layer 40, and a luminance enhancing sheet 50. The surface light source 1A further includes lenses 11 disposed between the blue LEDs 10 and the diffusion sheet 30 so as to cover the blue LEDs 10. The surface light source 1A emits planar white light from the forward surface of the luminance enhancing sheet 50 serving as the light exit surface of the surface light source 1A. As stated herein, the white means a color with a color temperature within a range of 3000 K to 10000 K.

The blue LED 10 emits blue light as a first colored light. The dominant emission wavelength of this blue light is, for example, 430 to 480 nm. As stated herein, the dominant emission wavelength is a wavelength at which the light emission luminance has a peak value. Equally spaced blue LEDs 10 are arranged in a matrix on the front surface of the reflecting plate 20. An optimal number of optimally spaced blue LEDs 10 are arranged suitably for the configuration of the surface light source 1A. For example, the number of the blue LEDs and the distance between them are determined according to the size and thickness of the surface light source 1A as well as the light distribution characteristic of the lens 11.

The lens 11 is placed in contact with the blue LED 10. The lens 11 allows blue light emitted from the blue LED 10 to enter there and spreads the blue light radially to emit the spread light. More specifically, the blue light emitted from the blue LED 10 has the highest intensity in the front direction that is the optical axis direction. This blue light is distributed in more oblique directions with respect to the optical axis direction by the action of the lens 11. That is, the lens 11 widens the distribution of light entering the lens 11. This makes it possible further to reduce the thickness of the surface light source 1A or to reduce the number of blue LEDs 10. The lens 11 is made of a transparent resin material such as a silicone or acrylic material. The lens 11 also may be made of a glass material.

The reflecting plate 20 has a flat plate shape, and is disposed behind the blue LEDs 10. At least the front surface of the reflecting plate 20 is formed of a white diffuse-reflection surface. Specifically, the diffuse-reflection surface is made of a white polyester material or the like. The reflecting plate 20 diffusely reflects the light that reaches the diffuse-reflection surface. That is, the light that reaches the reflecting plate 20 is reflected diffusely in the forward direction. The reflecting plate 20 may be composed of a substrate having a front surface on which the blue LEDs 10 are mounted and a reflecting layer that is formed on the front surface of this substrate so as to expose the portions in which the blue LEDs 10 are mounted.

The diffusion sheet 30 has a flat plate shape, and is disposed in front of the blue LEDs 10. The diffusion sheet 30 diffuses the light that enters the diffusion sheet 300 through its back surface. A part of the diffused light passes through the diffusion sheet 30 and is emitted from the front surface thereof. Another part of the diffused light returns in the back direction (to the side of the blue LEDs 10) by reflection.

The phosphor layer 40 has an approximately flat plate shape, and is disposed between the diffusion sheet 30 and the luminance enhancing sheet 50 described below. The phosphor layer 40 contains a phosphor (not shown). When this phosphor is exposed to blue light, it is excited to emit a second colored light, which is yellow light in the present embodiment. In other words, the phosphor converts the wavelength of blue light into a longer wavelength to emit yellow light. The dominant emission wavelength of the yellow light is 550 nm to 610 nm. The phosphor sheet 40 allows a part of the blue light that enters the phosphor sheet 40 through its back surface to directly pass through, and converts another part of the blue light into yellow light by the wavelength conversion effect of the phosphor and allows the yellow light to pass through. The blue light and the yellow light are mixed to form white light. Of course, if the amount of blue light is greater, bluish white light is obtained, and if the amount of yellow light is greater, yellowish white light is obtained.

The phosphor layer 40 is configured so that the fraction of the blue light converted into the yellow light per unit area (for example, a circular region with a diameter of 1 cm centered at an arbitrary position) by the phosphor layer 40 decreases as the distance from the optical axis L of each of the blue LEDs 10 increases.

Specifically, the phosphor layer 40 is a sheet 410 that is formed in such a shape that the thickness decreases as the distance from the optical axis L of each of the blue LEDs 10 increases. In the present embodiment, the thickness of the phosphor layer 40 is t1+t2 on the optical axis L of the blue LED 10, and decreases gradually as the distance from the optical axis L increases. Thus, the thickness is t2 at the farthest position from the optical axis L. In other words, the phosphor layer 40 has a shape composed of a plurality of conical portions 412 each having a height of t1 at a vertex that is a point on the optical axis of each of the blue LEDs 10, and a flat portion 411 having a height of t2. More specifically, the flat portion 411 holds the conical portions 412 and is partially exposed between the conical portions 412. In the present embodiment, the blue LEDs 10 are arranged in a matrix. Therefore, the part of the flat portion 411 exposed between the conical portions 412 has an approximately cross shape. The phosphor layer 40 has the same thickness of t1+t2 on the optical axes L of all the blue LEDs 10.

The luminance enhancing sheet 50 has a flat plate shape, and is disposed in front of the diffusion sheet 30. The luminance enhancing sheet 50 reflects back a part of the light that reaches its back surface. The luminance enhancing sheet 50 allows another part of the light to pass through and emits the light in such a way that the light is focused in the normal direction to its light exit surface. Thus, the front luminance of the emitted light is enhanced. Such a configuration is obtained by placing a prism on the front surface of the luminance enhancing sheet 50 to allow light to exit only at a specified angle.

The configuration of the surface light source 1A has been described so far. Next, the action of the surface light source 1A is described.

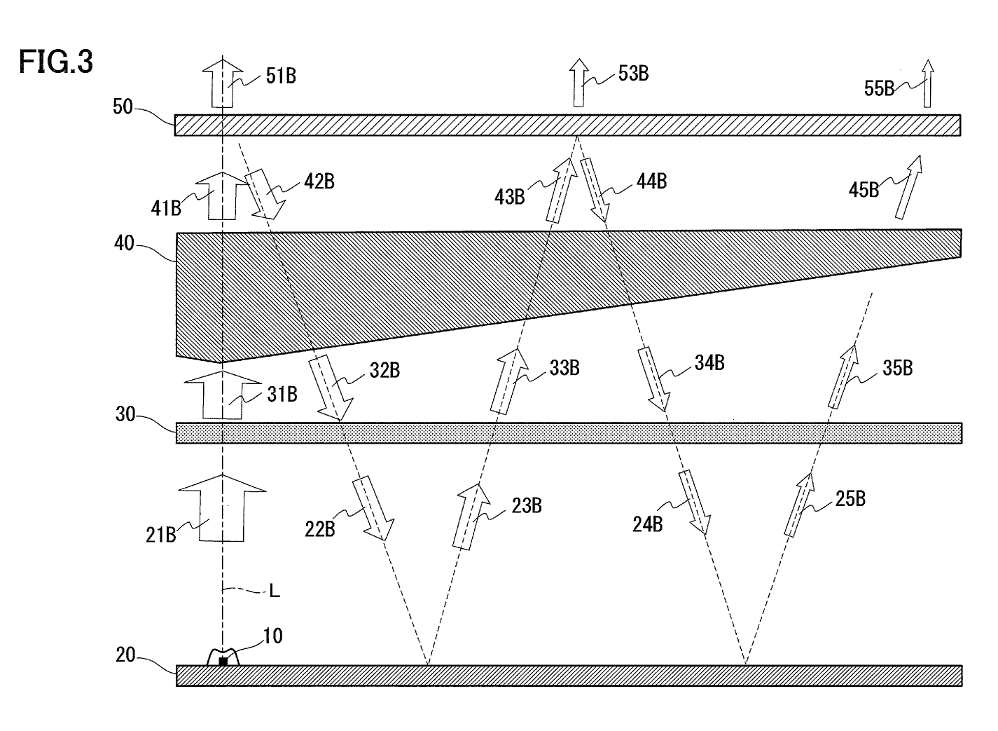

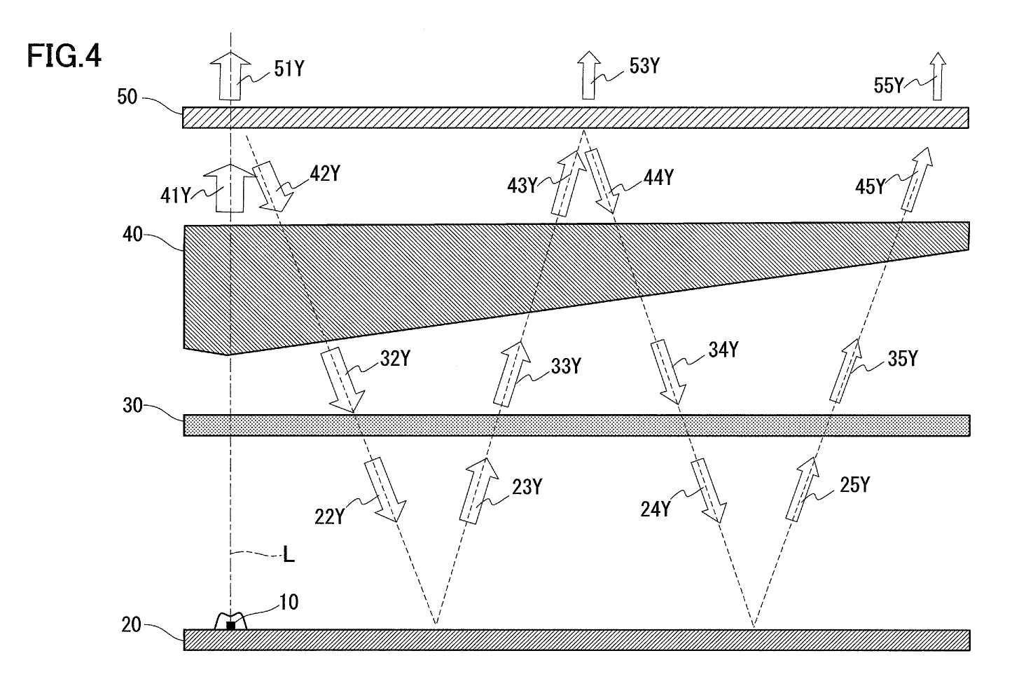

FIG. 3 is a diagram illustrating the reflections of blue light emitted from one of the blue LEDs in the surface light source 1A. FIG. 4 is a diagram illustrating the reflections of yellow light in the surface light source 1A. In these diagrams, the directions and widths of arrows schematically indicate the directions and intensities of light beams respectively.

In FIG. 3, first, the blue light emitted from the blue LED 10 is spread by the lens 11. In FIG. 3, the light emitted in the optical axis direction is shown as a representative example. Then, the blue light 21B reaches the diffusion sheet 30. The blue light 21B that has entered the diffusion sheet 30 is diffused, and a part of the light passes through the diffusion sheet 30 and another part thereof is reflected therefrom. Therefore, the intensity of a blue light 31B that has passed through the diffusion sheet 30 is lower than that of the blue light 21B. The blue light 31B that has passed through the diffusion sheet 30 reaches the phosphor layer 40. In the phosphor layer 40, a part of the blue light 31B strikes the phosphor (not shown) to excite the phosphor. Another part of the blue light 31B passes through the phosphor layer 40 without striking the phosphor. Therefore, the intensity of a blue light 41B that has passed through the phosphor sheet 40 is lower than that of the blue light 31B. The blue light 41B that has passed through the phosphor layer 40 reaches the luminance enhancing sheet 50. A part of the blue light 41B is reflected from the luminance enhancing sheet 50 and another part thereof passes through it depending on its incident angle to the luminance enhancing sheet 50. The blue light 51B that has passed through the luminance enhancing sheet 50 is emitted as the output of the surface light source 1A.

A blue light 42B that has been diffused by the diffusion sheet 30, incident obliquely on the luminance enhancing sheet 50, and thus reflected in a specified angle direction from the luminance enhancing sheet 50 reaches the phosphor layer 40 (in FIG. 3, blue lights 31B and 41B in this case are not shown). In the phosphor layer 40, a part of the blue light 42B strikes the phosphor (not shown) to excite the phosphor. Another part of the blue light 42B passes through the phosphor layer 40 without striking the phosphor. Therefore, the intensity of a blue light 32B that has passed through the phosphor layer 40 is lower than that of the blue light 42B. It should be noted that the blue light 42B has been reflected in the direction away from the optical axis L. Therefore, the phosphor layer 40 has a smaller thickness at the position where the blue light 42B passes than at the position where the blue light 31B passes. Therefore, the rate of decrease in the intensity from the blue light 42B to the blue light 32B is lower than that from the blue light 31B to the blue light 41B. The blue light 32B that has passed through the phosphor layer 40 reaches the diffusion sheet 30. The blue light 32B that has entered the diffusion sheet 30 is diffused, and a part of the light passes through the diffusion sheet 30 and another part thereof is reflected therefrom. Therefore, the intensity of a blue light 22B that has passed through the diffusion sheet 30 is lower than that of the blue light 32B. The blue light 22B that has passed through the diffusion sheet 30 reaches the reflecting plate 20. The blue light 22B is diffusely reflected from the reflecting plate 20 and again is incident on the diffusion sheet 300.

The blue light 22B is reflected from the reflecting plate 20, and the reflected blue light 23B passes through the diffusion sheet 30 and the phosphor layer 40, and exits the luminance enhancing sheet 50 through the front surface thereof. In this case, the blue lights 23B to 53B act in the same manner as the above-mentioned blue lights 21B to 51B. However, the phosphor layer 40 has an even smaller thickness at the position where the blue light 33B passes. Therefore, the rate of decrease in the intensity from the blue light 33B to the blue light 43B is lower than that from the blue light 42B to the blue light 32B.

The blue light 44B changes to the blue light 55B in the same manner. In this case, the intensity of light decreases but the rate of decrease declines in accordance with the thickness of the phosphor layer 40 decreases, as described above.

The blue light emitted from the blue LED 10 travels back and forth in the surface light source 1A in the manner as described above. However, since the blue light is output gradually to the outside of the surface light source 1A from the front surface of the luminance enhancing sheet 50, the intensity of the blue light is attenuated accordingly. The blue light also is diffused by each constituent member while its intensity is attenuated. Therefore, the blue light moves further away from the blue LED 10 as it travels back and forth in the surface light source 1A. Furthermore, the blue light passes through the phosphor layer 40 each time it travels in the surface light source 100. Therefore, a part of the blue light strikes the phosphor each time it passes through the phosphor layer 40, and the intensity of the blue light is attenuated accordingly. However, since the phosphor layer 40 becomes thinner as the distance from the optical axis increases, the rate of attenuation of the light intensity decreases accordingly.

Next, the yellow light emitted from the phosphor sheet 40 is described.

In FIG. 4, a yellow light 41Y emitted from the phosphor layer 40 reaches the luminance enhancing sheet 50. A part of the yellow light 41Y is reflected from the luminance enhancing sheet 50 and another part thereof passes through it depending on its incident angle to the luminance enhancing sheet 50. The yellow light 51Y that has passed through the luminance enhancing sheet 50 is emitted as the output of the surface light source 1A.

A yellow light 42Y that has been reflected in the same angle direction as the blue light 42B shown in FIG. 3 from the luminance enhancing sheet 50 reaches the phosphor layer 40. In the phosphor layer 40, the yellow light 42Y is not subjected to wavelength conversion. Therefore, a part of the yellow light 42Y is reflected from the phosphor layer 40 and another part thereof passes through the phosphor layer 40 while being diffused therein. Furthermore, in the phosphor layer 40, a part of the blue light 42B in FIG. 3 excites the phosphor and thus a new yellow light is generated. Therefore, a yellow light 32Y that has passed through the phosphor layer 40 has approximately the same intensity as or a higher intensity than the yellow light 42Y. The intensity of the yellow light 32Y may be lower than that of the yellow light 42Y due to the degree of reflection from the phosphor layer 40. However, even if the intensity decreases from the yellow light 42Y to the yellow light 32Y, the degree of this decrease is less than the degree of decrease in the intensity from the blue light 42B to the blue light 32B in FIG. 3. The yellow light 32Y that has passed through the phosphor layer 40 reaches the diffusion sheet 30. The yellow light 32Y that has entered the diffusion sheet 30 is diffused, and a part of the light passes through the diffusion sheet 30 and another part thereof is reflected therefrom. Therefore, the intensity of a yellow light 22Y that has passed through the diffusion sheet 30 is lower than that of the yellow light 32Y. The yellow light 22Y that has passed through the diffusion sheet 30 reaches the reflecting plate 20. The yellow light 22Y is diffusely reflected from the reflecting plate 20 and again is incident on the diffusion sheet 30.

The yellow light 22Y is reflected from the reflecting plate 20 and the reflected yellow light 23Y reaches the diffusion sheet 30. The yellow light 23Y that has entered the diffusion sheet 30 is diffused, and a part of the light passes through the diffusion sheet 30 and another part thereof is reflected therefrom. Therefore, the intensity of a yellow light 33Y that has passed through the diffusion sheet 30 is lower than that of the yellow light 23Y. The yellow light 33Y that has passed through the diffusion sheet 30 reaches the phosphor layer 40. In the phosphor layer 40, the yellow light 33Y is not subjected to wavelength conversion. Therefore, a part of the yellow light 33Y is reflected from the phosphor layer 40 and another part thereof passes through the phosphor layer 40 while being diffused therein. Furthermore, in the phosphor layer 40, a part of the blue light 33B in FIG. 3 excites the phosphor and thus a new yellow light is generated. Therefore, a yellow light 43Y that has passed through the phosphor layer 40 has approximately the same intensity as or a higher intensity than the yellow light 33Y. The intensity of the yellow light 43Y may be lower than that of the yellow light 33Y due to the degree of reflection from the phosphor layer 40. However, even if the intensity decreases from the yellow light 33Y to the yellow light 43Y, the degree of this decrease is less than the degree of decrease in the intensity from the blue light 33B to the blue light 43B in FIG. 3. Subsequently, the yellow lights 43Y and 53Y act in the same manner as the above⁻mentioned yellow light 41Y and 51Y. The yellow lights 44Y to 55Y act in the same manner as the above-mentioned yellow light 42Y to 53Y.

The yellow light generated in the phosphor sheet 40 travels back and forth in the surface light source 1A in the manner as described above. However, since the yellow light is output gradually to the outside of the surface light source 1A from the front surface of the luminance enhancing sheet 50, the intensity of the yellow light is attenuated accordingly. The yellow light is diffused by each constituent member while its intensity is attenuated. Therefore, the yellow light moves further away from the blue LED 10 as it travels back and forth in the surface light source 1A.

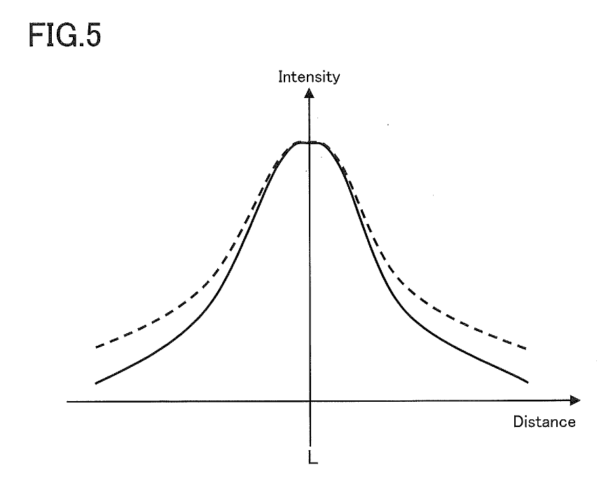

FIG. 5 shows the intensity distributions of lights on the light exit surface of the luminance enhancing sheet 50. The lights originate from light emitted in the optical axis direction from one of the blue LEDs 10. Specifically, FIG. 5 shows the intensities of lights obtained in the case where a light beam emitted from the blue LED 10 is scattered in all directions by the diffusion sheet 30 and the scattered light beams are emitted while traveling back and forth in the surface light source 1A. The vertical axis indicates the light intensity, and the horizontal axis indicates the distance from the optical axis. The solid line indicates the dominant wavelength of the blue LED 10, that is, the intensity of the blue light. The dashed line indicates the emission wavelength of the phosphor layer 40, that is, the intensity of the yellow light. Both of the lines represent the normalized intensities with respect to the intensities at the position of the optical axis. Since the blue light excites the phosphor in the phosphor layer 40, the intensity of the blue light decreases each time it passes through the phosphor sheet 40. Therefore, the intensity of the blue light decreases more sharply than that of the yellow light as the distance from the optical axis increases. Specifically, the chromaticity of the light from the light exit surface of the luminance enhancing sheet 50 changes (becomes more yellowish) as the distance from the optical axis of the blue LED 10 increases. However, since the phosphor layer 40 becomes thinner as the distance from the optical axis increases, the rate of decrease in the intensity of the blue light decreases accordingly. Therefore, the rate of decrease in the intensity of the blue light is lower than that in a conventional phosphor layer with a uniform thickness. As a result, the degree of change in the chromaticity decreases and thus color unevenness is reduced.

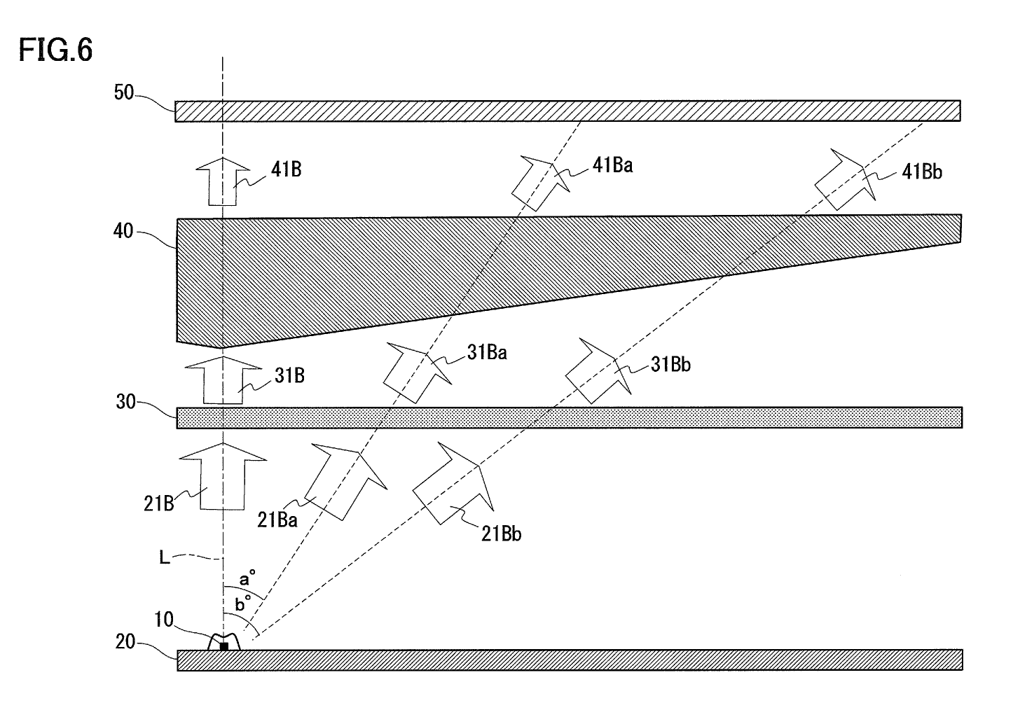

Next, lights that are emitted from the blue LED 10 in oblique directions with respect to the optical axis L and then emitted primarily from the luminance enhancing sheet 50 are described. FIG. 6 is a diagram illustrating the states of blue lights emitted at various angles from one of the blue LEDs in the surface light source 1A. The blue lights 21B to 41B on the optical axis act in the same manner as the above-mentioned blue lights 21B to 41B in FIG. 3. The blue light 21Ba is light emitted obliquely at an angle of a with respect to the optical axis L. The intensity of the blue light 21Ba is attenuated by the action of the diffusion sheet 30 and the blue light 21Ba changes to a blue light 31Ba. This phenomenon is almost the same as the phenomenon observed when the blue light 21B changes to the blue light 31B. The intensity of the blue light 31Ba is attenuated by the action of the phosphor layer 40 and the blue light 31Ba changes to a blue light 41Ba. The thickness of the phosphor layer 40 decreases as the distance from the optical axis L increases. Therefore, the phosphor layer 40 has a smaller thickness at the position where the blue light 31Ba passes through the phosphor layer 40 than at the position of the optical axis where the blue light 31B passes therethrough. FIG. 6 shows blue light traveling along the line at the angle of a, for the sake of simplicity. However, since the blue light is diffused by the diffusion sheet 30, the thickness of the phosphor layer 40 means the thickness in the optical axis direction when it is mentioned to explain the attenuation of the intensity. Therefore, the intensity of the blue light 31Ba decreases at a lower rate than that of the blue light 31B in the phosphor layer 40. Similarly, the blue light 21Bb is light emitted obliquely at an angle of b, which is greater than the angle a, with respect to the optical axis L. In this case, the blue light 31Bb that reaches the phosphor layer 40 passes through a position more distant from the optical axis L. Therefore, the intensity of the blue light 31Bb decreases at an even lower rate than that of the blue light 31Ba in the phosphor layer 40.

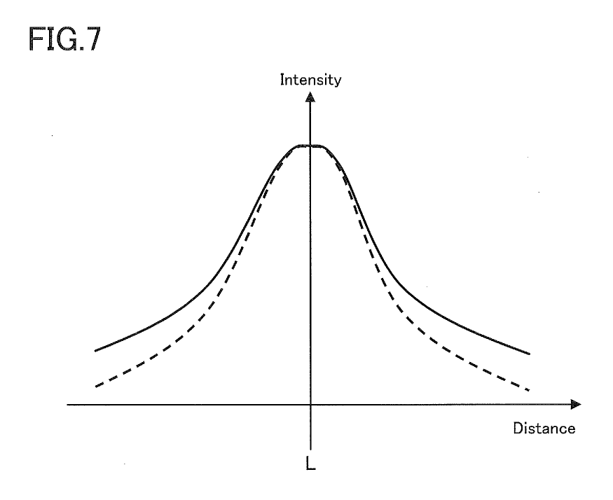

FIG. 7 shows the intensity distributions of lights on the light exit surface of the luminance enhancing sheet 50. The lights originate from lights emitted from one of the blue LEDs 10 and are emitted primarily from the luminance enhancing sheet. Specifically, FIG. 5 shows the intensity distributions obtained based on light emitted in the optical axis direction. The light forms, on the light exit surface of the luminance enhancing sheet 50, a part of these distributions directly and the rest of the distributions by reflection in the surface light source 1A. In contrast, FIG. 7 shows the intensity distributions obtained based on direct lights emitted at various angles from the blue LED 10. The direct lights form these distributions on the light exit surface of the luminance enhancing sheet 50. Needless to say, the light emitted at each of the angles in FIG. 7 forms the same intensity distributions as those of the reflected lights shown in FIG. 5. The vertical axis indicates the light intensity, and the horizontal axis indicates the distance from the optical axis. The solid line indicates the dominant wavelength of the blue LED 10, that is, the intensity of the blue light. The dashed line indicates the emission wavelength of the phosphor layer 40, that is, the intensity of the yellow light. Both of the lines represent the normalized intensities with respect to the intensities at the position of the optical axis. The light emitted from the blue LED 10 has the highest intensity in the optical axis direction, and the emission intensity decreases as the emission angle with respect to the optical axis increases. The thickness of the phosphor layer 40 decreases as the distance from the optical axis L increases. Although blue light is attenuated when it passes through the phosphor layer 40, the rate of attenuation decreases as the distance from the optical axis increases. Yellow light is generated in the phosphor layer 40. Since the thickness of the phosphor layer 40 decreases as the distance from the optical axis increases, the degree of generation of yellow light also decreases accordingly. As a result, the chromaticity of the light from the light exit surface of the luminance enhancing sheet 50 changes (becomes more bluish) as the distance from the optical axis of the blue LED 10 increases. In this case, the chromaticity changes inversely to the above-mentioned case of FIG. 5.

The surface light source 1A has the combined characteristics of the above-described action shown in FIG. 5 and action shown in FIG. 7. Therefore, the changes in chromaticity caused by these actions can be compensated by each other. Specifically, the unevenness of yellow color caused by the reflected light can be compensated by the unevenness of blue color caused by the direct light. As a result, a surface light source with reduced color unevenness can be obtained.

In the present embodiment, the blue LED 10 is an example of the light emitting element. As the light emitting element of the present invention, a red LED that emits red light or a green LED that emits green light can be employed instead of the blue LED 10 that emits blue light. That is, the first colored light of the present invention is not limited to the blue light. Alternatively, the light emitting element of the present invention may be an organic EL device, for example.

In the present embodiment, the reflecting plate 20 is an example of the first reflecting member. The first reflecting member of the present invention need not necessarily be a rigid plate. For example, it may be a flexible sheet or film.

In the present embodiment, the diffusion sheet 30 is an example of the diffusing member. The diffusing member of the present invention need not necessarily be a flexible sheet. For example, it may be a rigid plate.

The phosphor layer 40 need not necessarily be a flexible sheet 410. For example, it may be a rigid plate.

Furthermore, although the phosphor layer 40 is disposed between the diffusion sheet 30 and the luminance enhancing sheet 50 in the present embodiment, the configuration is not limited to this. For example, the phosphor layer 40 may be disposed between the reflecting plate 20 and the diffusion sheet 30. This means, in short, that the effect of reducing color unevenness can be obtained as long as the phosphor layer 40 is disposed between the reflecting plate 20 and the luminance enhancing sheet 50. For example, if a diffusing plate with high mechanical strength is used as the diffusing member, another sheet or the like can be held by this diffusing plate. Therefore, if the phosphor layer 40 is disposed between the diffusion sheet 30 and the luminance enhancing sheet 50, it can be held by the diffusing member, and no other holding mechanism is required.

Furthermore, although the phosphor layer 40 is configured such that the thickness thereof decreases gradually from the vertex that is the position of the optical axis of each blue LED as the distance from the optical axis increases, its configuration is not limited to this. For example, the phosphor layer 40 may be configured such that the thickness decreases stepwise. Also with such a configuration, the effect of reducing color unevenness can be obtained. This means, in short, that the phosphor layer 40 only needs to have a smaller thickness at a position around the optical axis of the light emitting element than on the optical axis thereof.

In the present embodiment, the phosphor layer 40 has the same thickness at positions on the optical axes of all the light emitting elements. When the phosphor layer 40 has the same thickness on the optical axes of all the light emitting elements, color unevenness in all the light emitting elements can be reduced in the same manner.

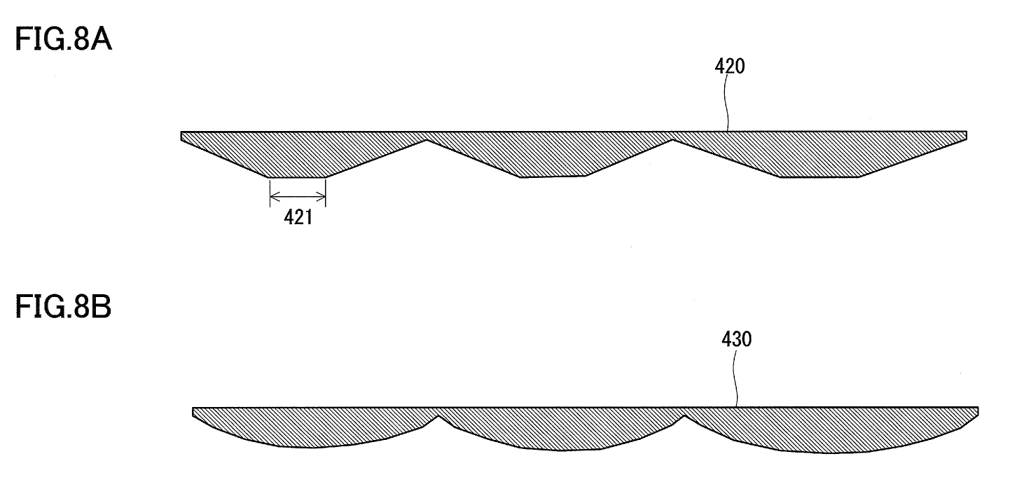

In the present embodiment, although the phosphor layer 40 is a sheet 410 having a shape composed of a plurality of conical portions 412 each having a height of t1 at a vertex that is a point on the optical axis of each blue LED 10 and a flat portion 411 having a thickness of t2, the configuration of the phosphor layer 40 is not limited to this. For example, as shown in FIG. 8A, the phosphor layer 40 may be a sheet 420 in which flat surface portions 421 having no vertex are formed at positions on the optical axes L. Alternatively, as shown in FIG. 8B, the phosphor layer 40 may be a sheet 430 having a plurality of protruding portions. Each of these protruding portions has a shape with a curved generatrix, that is, a shape like a portion of a sphere, unlike a cone with a straight generatrix. In the present embodiment, although the conical portions 412 are formed on the back surface of the phosphor layer 40 so that the vertices of the conical portions 412 point in the back direction, the configuration of the phosphor layer 40 is not limited to this. The conical portions 412 may be formed on the front surface of the phosphor layer 40 so that the vertices of the conical portions 412 point in the front direction. The conical portions may be formed on both of the front and back surfaces.

In the present embodiment, the luminance enhancing sheet 50 is an example of the second reflecting member. The luminance enhancing sheet 50 reflects back a part of the incident light, and allows another part of the light to pass through and emits the light in such a way that the light is focused in the normal direction to its light exit surface, so that the front luminance of the emitted light is enhanced. However, the second reflecting member of the present invention is not limited to this. The second reflecting member may be configured in another manner as long as it allows light that reaches its back surface to pass through while reflecting a part of the light therefrom. For example, the second reflecting member may be configured in such a manner that when a liquid crystal display apparatus is constructed using the second reflecting member, it reflects only polarized components of light that are to be absorbed by a liquid crystal panel and allows the rest of the light to pass through. In this configuration, since the reflected polarized light is unpolarized when it is again reflected from the first reflecting member, a part of the unpolarized light is newly allowed to pass through the luminance enhancing sheet. With this configuration, the components absorbed by the liquid crystal panel are reduced and thus the luminance is enhanced. The second reflecting member of the present invention need not necessarily be a flexible sheet. For example, it may be a rigid plate.

Moreover, although the phosphor layer 40 has the phosphor that converts the blue light into the yellow light as the second colored light in the present embodiment, the configuration is not limited to this. For example, the phosphor layer 40 may have a phosphor that converts the blue light into red light and a phosphor that converts the blue light into green light. More specifically, the second colored light of the present invention may include red light and green light. With this configuration, the blue light emitted from the light emitting element can be mixed with the red light and the green light generated by wavelength conversion by the phosphors so as to create white light. Furthermore, the colored light created in the phosphor layer 40 by the mixture of the first colored light and the second colored light need not necessarily be white light and may be light of another particular color.

### Second Embodiment

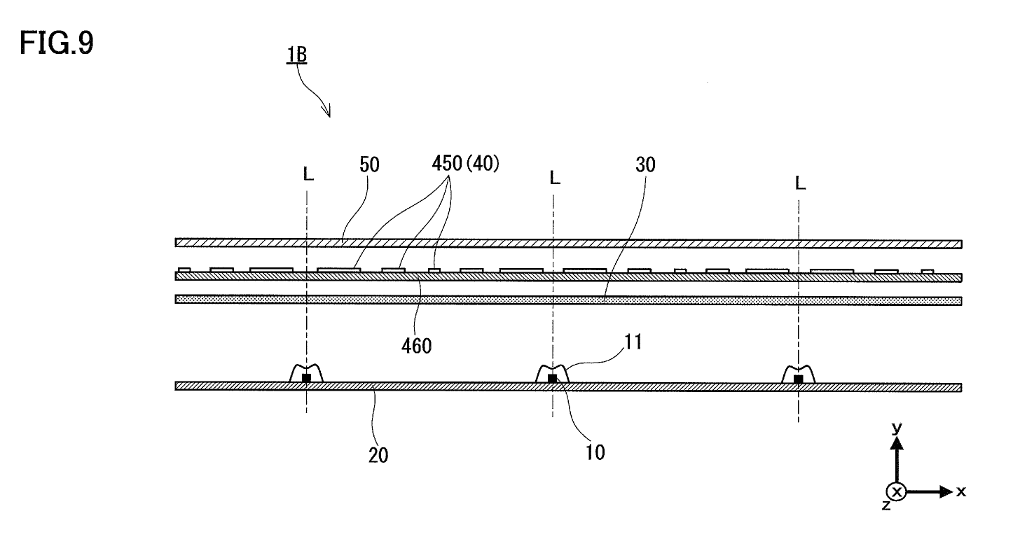

Next, a surface light source 1B according to a second embodiment of the present invention is described with reference to FIG. 9. The present embodiment is different from the first embodiment in that the phosphor layer 40 is formed on a base layer 460.

The phosphor layer 40 is configured so that the fraction of blue light converted into yellow light per unit area by the phosphor layer 40 decreases as the distance from the optical axis L of each of the blue LEDs 10 increases, as in the first embodiment. However, the specific configuration of the phosphor layer 40 is different.

In the present embodiment, the phosphor layer 40 is a set of distributed elements that are printed on the base layer 460 so as to occupy a lower percentage of the circumference of a circle centered on the optical axis L of each of the blue LEDs 10 as the distance from the optical axis L of each of the blue LEDs 10 increases, and is composed of a plurality of dots 450. In the present embodiment, a layer including the phosphor layer 40 and an empty space between the dots 450 is referred to as a wavelength control layer.

The base layer 460 has a flat plate shape, and is disposed between the diffusion sheet 30 and the luminance enhancing sheet 50. The base layer 460 can be formed of a sheet made of PET or the like, for example. The phosphor layer 40 is formed on the front surface of the base layer 460.

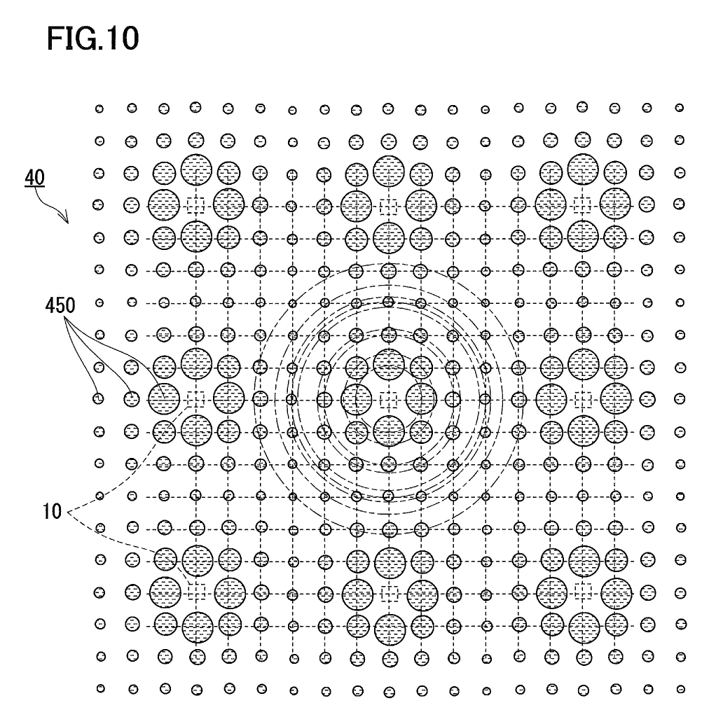

As shown in FIG. 10, the dots 450 constituting the phosphor layer 40 are formed so that the diameters of the dots 450 decrease as the distance from the optical axis L of each of the blue LEDs 10 increases. Squares formed by dashed lines represent the positions below which the blue LEDs 10 are located. The phosphor layer 401 is formed of a set of dots that are printed on the intersections of the rows and columns of a matrix drawn with dashed lines. The diameters of the dots decrease as the distance between the optical axis of the blue LED 10 and the matrix intersection increases. With the phosphor layer 40 configured as such, it is possible to decrease the fraction of blue light converted into yellow light per unit area by the phosphor layer 40 as the distance from the optical axis L of each of the blue LEDs 10 increases.

Next, the action of the surface light source 1B is described.

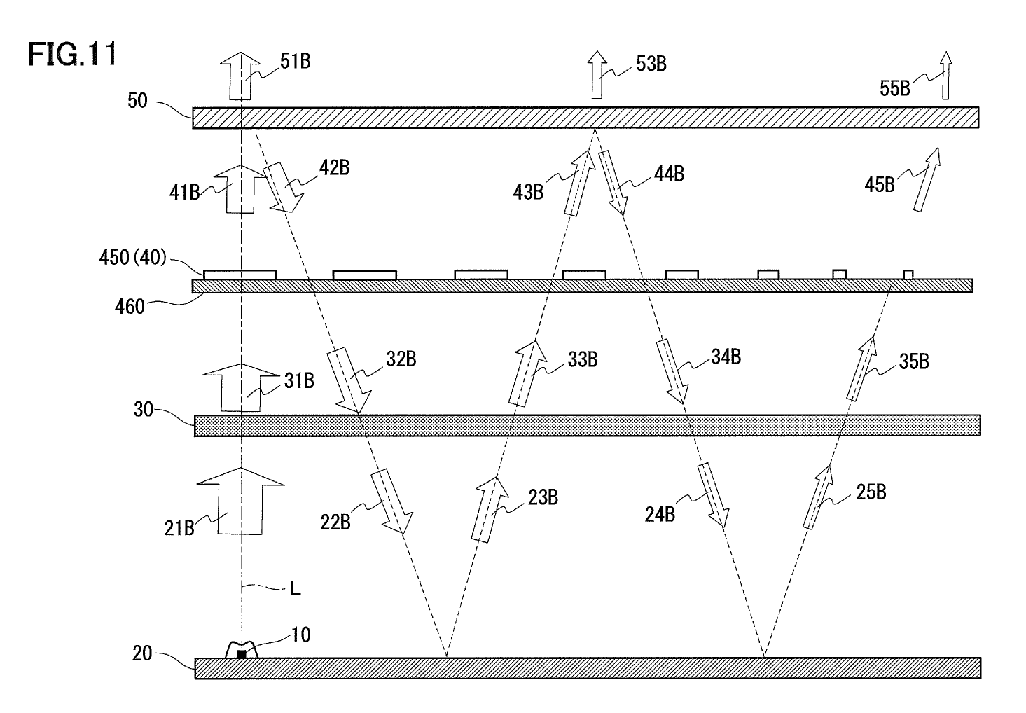

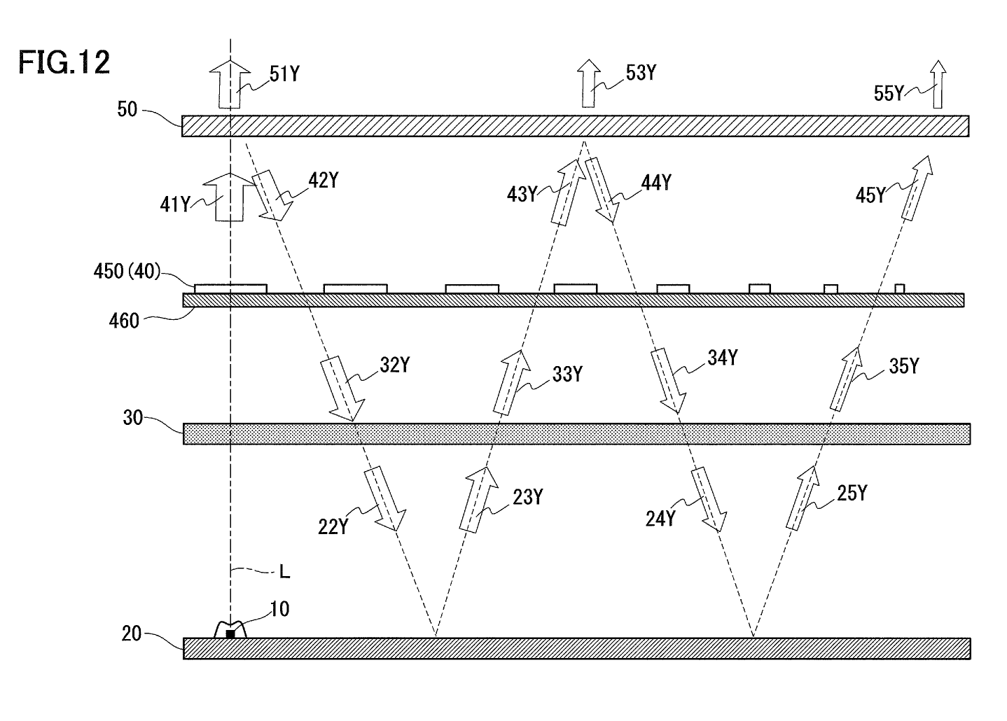

FIG. 11 is a diagram illustrating the reflections of blue light emitted from one of blue LEDs in the surface light source 1B, and FIG. 12 is a diagram illustrating the reflections of yellow light in the surface light source 1B. In these diagrams, the directions and widths of arrows schematically indicate the directions and intensities of light beams respectively. FIG. 11 is illustrated as if the dot 450 is located on the optical axis L, but it is illustrated to explain the action in an easy-to-understand manner, and the dot 450 may be located as shown in FIG. 9 and FIG. 10 or in FIG. 11. The same applies to the relationship between FIG. 12 and FIGS. 9 and 10.

In FIG. 11, first, the blue light emitted from the blue LED 10 is spread by the lens 11. In FIG. 11, the light emitted in the optical axis direction is shown as a representative example. Then, the blue light 21B reaches the diffusion sheet 30. The blue light 21B that has entered the diffusion sheet 30 is diffused, and a part of the light passes through the diffusion sheet 30 and another part thereof is reflected therefrom. Therefore, the intensity of a blue light 31B that has passed through the diffusion sheet 30 is lower than that of the blue light 21B. The blue light 31B that has passed through the diffusion sheet 30 passes through the base layer 460 and then reaches the wavelength control layer. In the phosphor layer 40 in the wavelength control layer, a part of the blue light 31B strikes the phosphor (not shown) to excite the phosphor. Another part of the blue light 31B passes through the phosphor layer 40 without striking the phosphor. Therefore, the intensity of a blue light 41B that has passed through the wavelength control layer is lower than that of the blue light 31B. The blue light 41B that has passed through the wavelength control layer reaches the luminance enhancing sheet 50. A part of the blue light 41B is reflected from the luminance enhancing sheet 50 and another part thereof passes through it depending on its incident angle to the luminance enhancing sheet 50. The blue light 51B that has passed through the luminance enhancing sheet 50 is emitted as the output of the surface light source 1B.

A blue light 42B that has been diffused by the diffusion sheet 30, incident obliquely on the luminance enhancing sheet 50, and thus reflected in a specified angle direction from the luminance enhancing sheet 50 reaches the wavelength control layer (in FIG. 11, blue lights 31B and 41B in this case are not shown). In the phosphor layer 40 in the wavelength control layer, a part of the blue light 42B strikes the phosphor (not shown) to excite the phosphor. Another part of the blue light 42B passes through the phosphor layer 40 without striking the phosphor. Therefore, the intensity of a blue light 32B that has passed through the wavelength control layer is lower than that of the blue light 42B. It should be noted that the blue light 42B is reflected in the direction away from the optical axis L. Therefore, the phosphor layer 40 occupies a lower percentage of the circumference of a circle centered on the optical axis L at the position where the blue light 42B passes than at the position where the blue light 31B passes. In other words, the amount of the blue light 42B that is incident on the phosphor layer 40 is less than the amount of the blue light 32B that is incident on the phosphor layer 40. Therefore, the rate of decrease in the intensity from the blue light 42B to the blue light 32B is lower than that from the blue light 31B to the blue light 41B. The blue light 32B that has passed through the wavelength control layer passes through the base layer 460 and then reaches the diffusion sheet 30. The blue light 32B that has entered the diffusion sheet 30 is diffused, and a part of the light passes through the diffusion sheet 30 and another part thereof is reflected therefrom. Therefore, the intensity of a blue light 22B that has passed through the diffusion sheet 30 is lower than that of the blue light 32B. The blue light 22B that has passed through the diffusion sheet 30 reaches the reflecting plate 20. The blue light 22B is diffusely reflected from the reflecting plate 20 and again is incident on the diffusion sheet 30.

The blue light 22B is reflected from the reflecting plate 20, and the reflected blue light 23B passes through the diffusion sheet 30, the base layer 460 and the wavelength control layer including the phosphor layer 40, and exits the luminance enhancing sheet 50 through the front surface thereof. In this case, the blue lights 23B to 53B act in the same manner as the above-mentioned blue lights 21B to 51B. However, the phosphor layer 40 occupies an even lower percentage of the circumference of a circle centered on the optical axis L at the position where the blue light 33B passes. Therefore, the rate of decrease in the light intensity from the blue light 33B to the blue light 43B is lower than that from the blue light 42B to the blue light 32B.

The blue light 44B changes to the blue light 55B in the same manner. In this case, the intensity of light decreases, but the rate of decrease declines in accordance with the percentage of the circumference of a circle centered on the optical axis L that the phosphor layer 40 occupies, as described above.

The blue light emitted from the blue LED 10 travels back and forth in the surface light source 1B in the manner as described above. However, since the blue light is output gradually to the outside of the surface light source 1B from the front surface of the luminance enhancing sheet 50, the intensity of the blue light is attenuated accordingly. The blue light also is diffused by each constituent member while its intensity is attenuated. Therefore, the blue light moves further away from the blue LED 10 as it travels back and forth in the surface light source 1B. Furthermore, a part of the blue light passes through the phosphor layer 40 each time it travels one way in the surface light source 1B. Therefore, a part of the blue light strikes the phosphor each time it passes through the phosphor layer 40, and the intensity of the blue light is attenuated accordingly. However, since the percentage occupied by the phosphor layer 40 decreases as the distance from the optical axis increases, the rate of attenuation of the light intensity decreases accordingly.

Next, the yellow light emitted from the phosphor sheet 40 is described.

In FIG. 12, a yellow light 41Y emitted from the phosphor layer 40 reaches the luminance enhancing sheet 50. A part of the yellow light 41Y is reflected from the luminance enhancing sheet 50 and another part thereof passes through it depending on its incident angle to the luminance enhancing sheet 50. The yellow light 51Y that has passed through the luminance enhancing sheet 50 is emitted as the output of the surface light source 1B.

A yellow light 42Y that has been reflected in the same angle direction as the blue light 42B shown in FIG. 11 from the luminance enhancing sheet 50 reaches the wavelength control layer. In the phosphor layer 40 in the wavelength control layer, the yellow light 42Y is not subjected to wavelength conversion. Therefore, a part of the yellow light 42Y is reflected from the phosphor layer 40 and another part thereof passes through the phosphor layer 40 while being diffused therein. Furthermore, in the phosphor layer 40, a part of the blue light 42B in FIG. 11 excites the phosphor and thus a new yellow light is generated. Therefore, a yellow light 32Y that has passed through the wavelength control layer has approximately the same intensity as or a higher intensity than the yellow light 42Y. The intensity of the yellow light 32Y may be lower than that of the yellow light 42Y due to the degree of reflection from the phosphor layer 40. However, even if the intensity decreases from the yellow light 42Y to the yellow light 32Y, the degree of this decrease is less than the degree of decrease in the intensity from the blue light 42B to the blue light 32B in FIG. 11. The yellow light 32Y that has passed through the wavelength control layer passes through the base layer 460 and then reaches the diffusion sheet 30. The yellow light 32Y that has entered the diffusion sheet 30 is diffused, and a part of the light passes through the diffusion sheet 30 and another part thereof is reflected therefrom. Therefore, the intensity of a yellow light 22Y that has passed through the diffusion sheet 30 is lower than that of the yellow light 32Y. The yellow light 22Y that has passed through the diffusion sheet 30 reaches the reflecting plate 20. The yellow light 22Y is diffusely reflected from the reflecting plate 20 and again is incident on the diffusion sheet 30.

The yellow light 22Y is reflected from the reflecting plate 20 and the reflected yellow light 23Y reaches the diffusion sheet 30. The yellow light 23Y that has entered the diffusion sheet 30 is diffused, and a part of the light passes through the diffusion sheet 30 and another part thereof is reflected therefrom. Therefore, the intensity of a yellow light 33Y that has passed through the diffusion sheet 30 is lower than that of the yellow light 23Y. The yellow light 33Y that has passed through the diffusion sheet 30 passes through the base layer 460 and then reaches the wavelength control layer. In the phosphor layer 40 in the wavelength control layer, the yellow light 33Y is not subjected to wavelength conversion. Therefore, a part of the yellow light 33Y is reflected from the phosphor layer 40 and another part thereof passes through the phosphor layer 40 while being diffused therein. Furthermore, in the phosphor layer 40, a part of the blue light 33B in FIG. 11 excites the phosphor and thus a new yellow light is generated. Therefore, a yellow light 43Y that has passed through the wavelength control layer has approximately the same intensity as or a higher intensity than the yellow light 33Y. The intensity of the yellow light 43Y may be lower than that of the yellow light 33Y due to the degree of reflection from the phosphor layer 40. However, even if the intensity of the yellow light 33Y decreases to that of the yellow light 43Y, the degree of this decrease is less than the degree of decrease in the intensity from the blue light 33B to the blue light 43B in FIG. 11. Subsequently, the yellow lights 43Y and 53Y act in the same manner as the above-mentioned yellow light 41Y and 51Y. The yellow lights 44Y to 55Y act in the same manner as the above-mentioned yellow light 42Y to 53Y.

The yellow light generated in the phosphor sheet 40 travels back and forth in the surface light source 1B in the manner as described above. However, since the yellow light is output gradually to the outside of the surface light source 1B from the front surface of the luminance enhancing sheet 50, the intensity of the yellow light is attenuated accordingly. The yellow light also is diffused by each constituent member while its intensity is attenuated. Therefore, the yellow light moves further away from the blue LED 10 as it travels back and forth in the surface light source 1B.

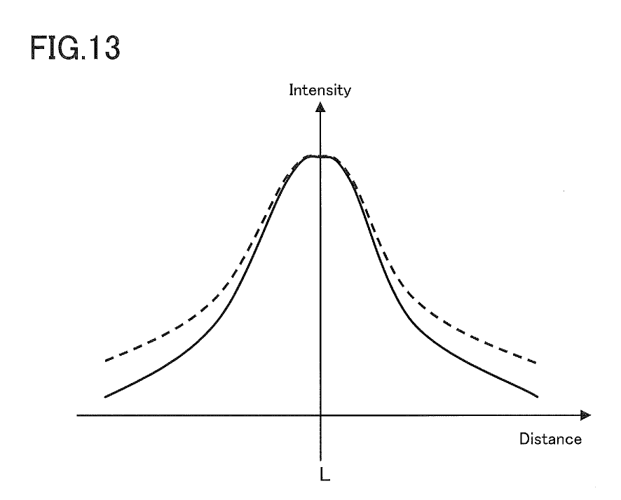

FIG. 13 shows the intensity distributions of lights on the light exit surface of the luminance enhancing sheet 50. The lights originate from light emitted in the optical axis direction from one of the blue LEDs 10. Specifically, FIG. 13 shows the intensities of lights obtained in the case where a light beam emitted from the blue LED 10 is scattered in all directions by the diffusion sheet 30 and the scattered light beams are emitted while traveling back and forth in the surface light source 1B. The vertical axis indicates the light intensity, and the horizontal axis indicates the distance from the optical axis. The solid line indicates the dominant wavelength of the blue LED 10, that is, the intensity of the blue light. The dashed line indicates the emission wavelength of the phosphor layer 40, that is, the intensity of the yellow light. Both of the lines represent the normalized intensities with respect to the intensities at the position of the optical axis. Since the blue light excites the phosphor in the phosphor layer 40, the intensity of the blue light decreases each time it passes through the phosphor layer 40. Therefore, the intensity of the blue light decreases more sharply than that of the yellow light as the distance from the optical axis increases. Specifically, the chromaticity of the light from the light exit surface of the luminance enhancing sheet 50 changes (becomes more yellowish) as the distance from the optical axis of the blue LED 10 increases. However, since the percentage occupied by the phosphor layer 40 decreases as the distance from the optical axis increases, the rate of decrease in the intensity of the blue light decreases accordingly. Therefore, the rate of decrease in the intensity of the blue light is lower than that in a conventional wavelength conversion sheet containing a uniformly distributed phosphor. As a result, the degree of change in the chromaticity decreases and thus color unevenness is reduced.

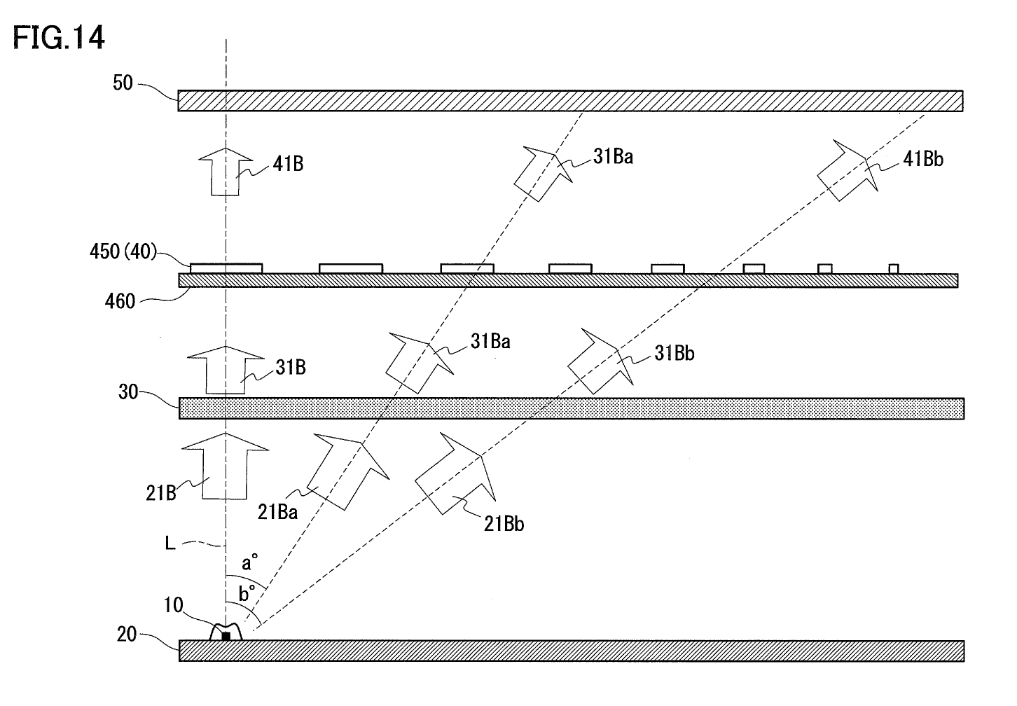

Next, lights that are emitted from the blue LED 10 in oblique directions with respect to the optical axis L and then emitted primarily from the luminance enhancing sheet 50 are described. FIG. 14 is a diagram illustrating the states of blue lights emitted at various angles from one of the blue LEDs in the surface light source 1B. The blue lights 21B to 41B on the optical axis act in the same manner as the above-mentioned blue lights 21B to 41B in FIG. 11. The blue light 21Ba is light emitted obliquely at an angle of a with respect to the optical axis L. The intensity of the blue light 21Ba is attenuated by the action of the diffusion sheet 30 and the blue light 21Ba changes to a blue light 31Ba. This phenomenon is almost the same as the phenomenon observed when the blue light 21B changes to the blue light 31B. The intensity of the blue light 31Ba is attenuated by the action of the phosphor layer 40 and the blue light 31Ba changes to a blue light 41Ba. The percentage occupied by the phosphor layer 40 decreases as the distance from the optical axis L increases. Therefore, the amount of the blue light that is incident on the phosphor layer 40 at the position where the blue light 31Ba passes is smaller than that at the position of the optical axis where the blue light 31B passes. Therefore, the intensity of the blue light 31Ba decreases at a lower rate than that of the blue light 31B in the phosphor layer 40. Similarly, the blue light 21Bb is light emitted obliquely at an angle of b, which is greater than the angle a, with respect to the optical axis L. In this case, the blue light 31Bb that reaches the wavelength control layer including the phosphor layer 40 passes a position more distant from the optical axis L. Therefore, the intensity of the blue light 31Bb decreases at an even lower rate than that of the blue light 31Ba in the phosphor layer 40.

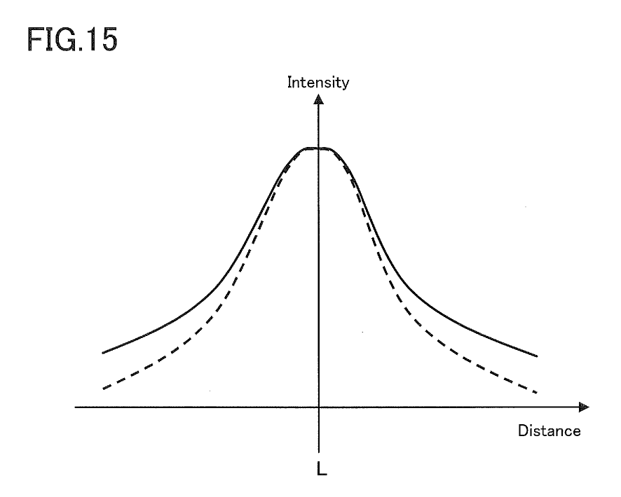

FIG. 15 shows the intensity distributions of lights on the light exit surface of the luminance enhancing sheet 50. The lights originate from lights emitted from one of the blue LEDs 10 and are emitted primarily from the luminance enhancing sheet. Specifically, FIG. 13 shows the intensity distributions obtained based on light emitted in the optical axis direction. The light forms, on the light exit surface of the luminance enhancing sheet 50, a part of these distributions directly and the rest of the distributions by reflection in the surface light source 1A. In contrast, FIG. 15 shows the intensity distributions obtained based on direct lights emitted at various angles from the blue LED 10. The direct lights form these distributions on the light exit surface of the luminance enhancing sheet 50. Needless to say, the light emitted at each of the angles in FIG. 15 forms the same intensity distributions as those of the reflected lights shown in FIG. 13. The vertical axis indicates the light intensity, and the horizontal axis indicates the distance from the optical axis. The solid line indicates the dominant wavelength of the blue LED 10, that is, the intensity of the blue light. The dashed line indicates the emission wavelength of the phosphor layer 40, that is, the intensity of the yellow light. Both of the lines represent the normalized intensities with respect to the intensities at the position of the optical axis. The light emitted from the blue LED 10 has the highest intensity in the optical axis direction, and the emission intensity decreases as the emission angle with respect to the optical axis increases. In this case, the percentage occupied by the phosphor layer 40 decreases as the distance from the optical axis L increases. Although blue light is attenuated when it passes through the phosphor layer 40, the rate of attenuation decreases as the distance from the optical axis increases. Yellow light is generated in the phosphor layer 40. Since the percentage occupied by the phosphor layer 40 decreases as the distance from the optical axis increases, the degree of generation of yellow light also decreases accordingly. As a result, the chromaticity of the light from the light exit surface of the luminance enhancing sheet 50 changes (becomes more bluish) as the distance from the optical axis of the blue LED 10 increases. In this case, the chromaticity changes inversely to the above-mentioned case of FIG. 13.

The surface light source 1B has the combined characteristics of the above-described action shown in FIG. 13 and action shown in FIG. 15. Therefore the changes in chromaticity caused by these actions can be compensated by each other. Specifically, the unevenness of yellow color caused by the reflected light can be compensated by the unevenness of blue color caused by the direct light. As a result, a surface light source with reduced color unevenness can be obtained.

In the present embodiment, the phosphor layer 40 is configured in such a manner that the percentage occupied by the phosphor layer 40 is changed according to the change in the diameters of the equally-spaced dots 450. However, the configuration of the phosphor layer of the present invention is not limited to this as long as it is configured to occupy a lower percentage of the circumference of a circle centered on the optical axis of each of the light emitting elements as the distance from the optical axis of each of the light emitting elements increases. For example, the phosphor layer 40 may be composed of dots with the same diameter. In this case, it is configured so that the density of the dots decreases as the distance from the optical axis of each of the light emitting elements increases. The phosphor layer of the present invention need not necessarily be composed of dots. It may be composed of printed concentric circles centered at the position of the optical axis of the blue LED 10. Also with such a configuration, the percentage occupied by the phosphor layer can be changed by changing the width of the concentric circles or the distance between the concentric circles.

Needless to say, some of the other configurations described in the first embodiment can also be employed in the second embodiment.

(First Modification)

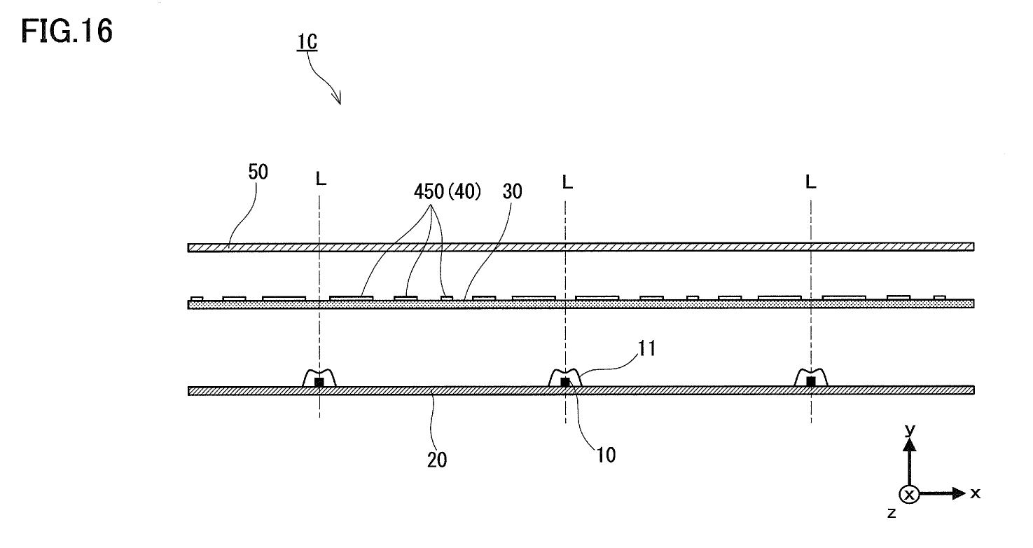

Next, a surface light source 1C according to a first modification is described with reference to FIG. 16. FIG. 16 is a schematic cross-sectional view of the surface light source 1C. The first modification is different from the second embodiment in that the phosphor layer 40 is formed on the diffusion sheet 30.

The phosphor layer 40 is composed of the dots 450 that are printed on the front surface of the diffusion sheet 30. That is, the diffusion sheet 30 is used as the base layer 460 in the second embodiment. Also with such a configuration, the effect of reducing color unevenness can be obtained as in the second embodiment. Furthermore, with such a configuration, the structure of the surface light source 1C can be simplified, and thus the manufacturing cost thereof can be reduced.

(Second Modification)

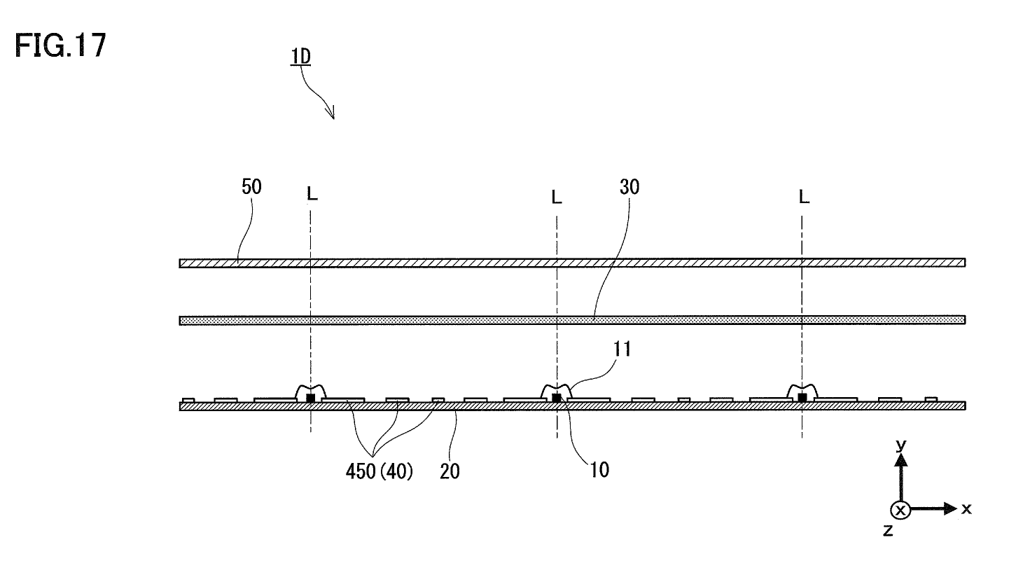

Next, a surface light source 1D according to a second modification is described with reference to FIG. 17. FIG. 17 is a schematic cross-sectional view of the surface light source 1D. The second modification is different from the second embodiment in that the phosphor layer 40 is formed on the reflecting plate 20.

The phosphor layer 40 is composed of the dots 450 that are printed on the front surface of the reflecting plate 20. That is, the reflecting plate 20 is used as the base layer 460 in the second embodiment. Also with such a configuration, the effect of reducing color unevenness can be obtained at least for the reflected light as described with reference to FIG. 11 to FIG. 13 in the second embodiment.

The configurations of the second embodiment and the first modification require an adjustment to position the optical axis of the blue LED 10 at the position where the phosphor layer 40 occupies a high percentage of the member holding the phosphor layer 40. In the configuration of the second modification, the phosphor layer 40 is printed directly on the reflecting plate 20 on which the blue LEDs 10 are to be arranged. Therefore, the phosphor layer 40 and the blue LEDs 10 can be positioned easily.

<Liquid Crystal Display>

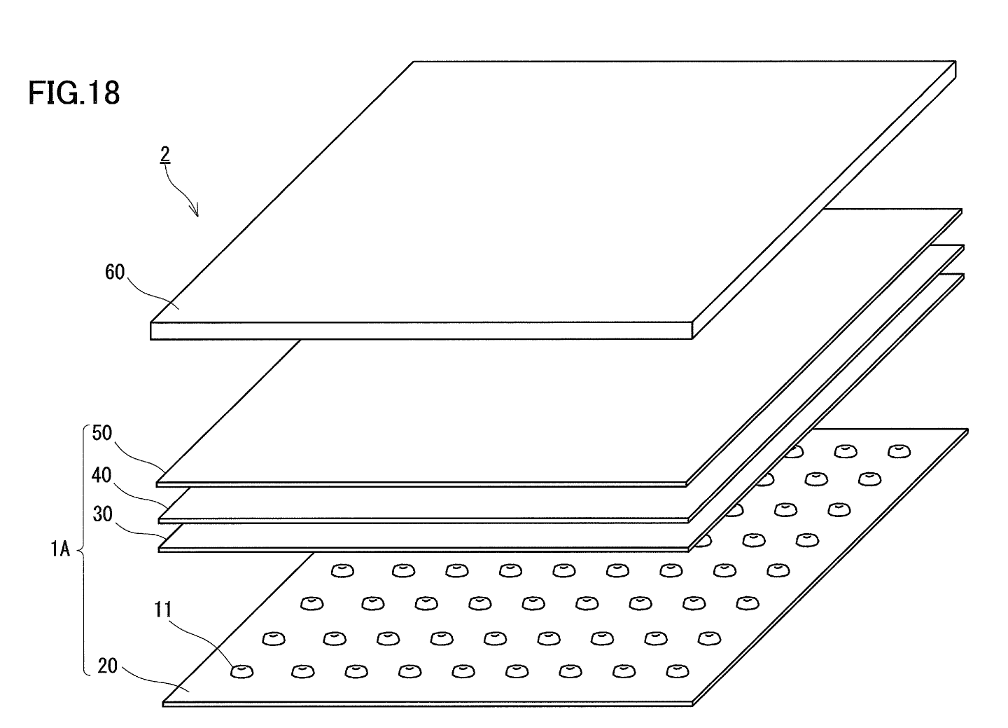

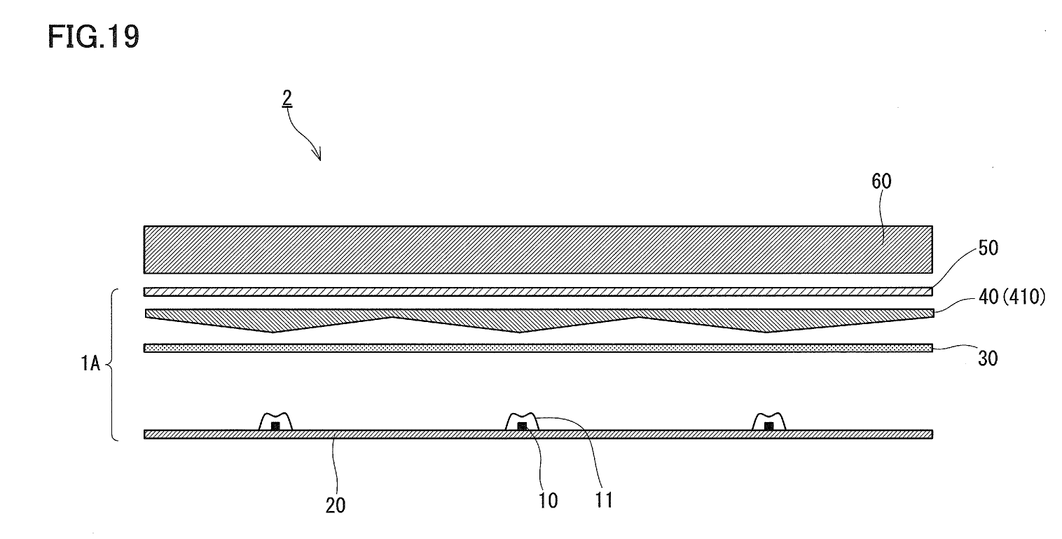

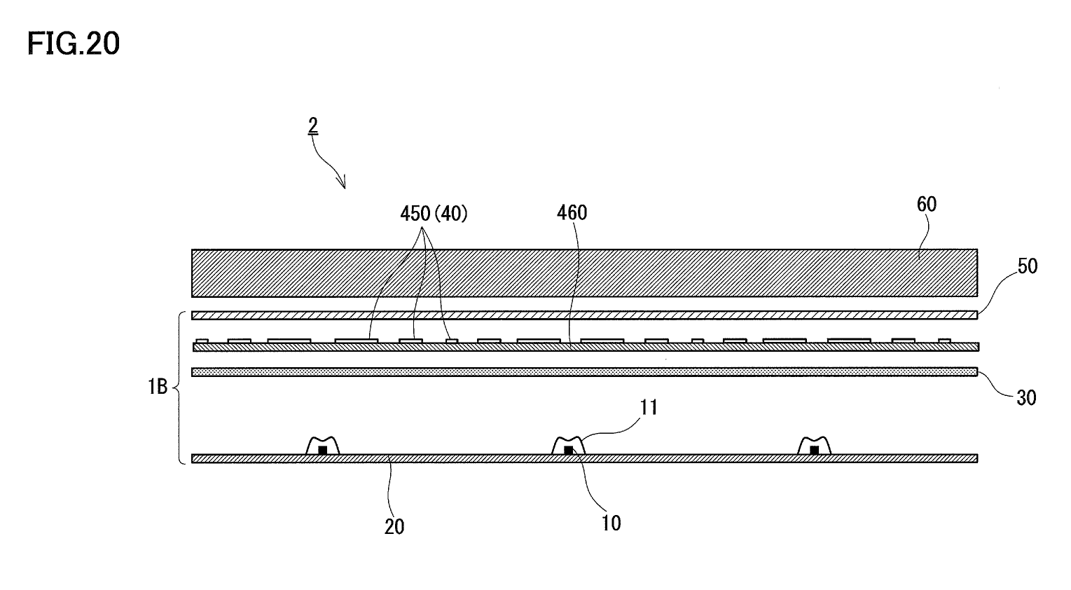

Next, a liquid crystal display apparatus 2 including the surface light source 1A according to the first embodiment or the surface light source 1B according to the second embodiment is described with reference to FIG. 18 to FIG. 20. FIG. 18 is a schematic perspective view showing the structure of the liquid crystal display apparatus 2 including the surface light source 1A. FIG. 19 is a schematic cross-sectional view of the liquid crystal display apparatus 2 including the surface light source 1A, taken along the x-y plane. FIG. 20 is a schematic cross-sectional view of the liquid crystal display apparatus 2 including the surface light source 1B, instead of the surface light source 1A, taken along the x-y plane. FIG. 18 to FIG. 20 each show only the characteristic parts of this configuration, and other parts are partially omitted.

The liquid crystal display apparatus 2 includes the surface light source 1A of the first embodiment (or the surface light source 1B of the second embodiment) and a liquid crystal panel 60 for displaying an image.

The liquid crystal panel 60 is irradiated from behind with light emitted from the surface light source 1A (or 1B) serving as a backlight of the liquid crystal display apparatus 2.

The liquid crystal panel 60 includes a polarizing plate, a color filter, a liquid crystal layer, etc, not shown. The liquid crystal panel 60 is made up of a plurality of pixels not shown. Each of the pixels controls how much light emitted from the backlight passes therethrough to display a desired image.

The above-mentioned liquid crystal display apparatus 2 including the surface light source 1A (or 1B) with less color unevenness can serve as a liquid crystal display apparatus with less color unevenness.

### INDUSTRIAL APPLICABILITY

The present invention is suitable for backlights used in liquid crystal display apparatuses and for liquid crystal display apparatuses including the backlights.

1. A surface light source comprising:
a plurality of light emitting elements that emit a first colored light;
a first reflecting member, disposed behind the light emitting elements, for reflecting light that reaches its front surface facing the light emitting elements;
a diffusing member, disposed in front of the light emitting elements, for diffusing light that enters the diffusing member and emitting the diffused light;
a second reflecting member, disposed in front of the diffusing member, for allowing light that reaches its back surface facing the diffusing member to pass through the second reflecting member while reflecting a part of the light; and
a phosphor layer, disposed between the first reflecting member and the second reflecting member, for allowing a part of the first colored light to pass through the phosphor layer and converting another part of the first colored light into a second colored light,
wherein the phosphor layer is configured so that the fraction of the first colored light converted into the second colored light per unit area by the phosphor layer decreases as a distance from an optical axis of each of the light emitting elements increases.

2. The surface light source according to claim 1, wherein the phosphor layer is a sheet that is disposed between the light emitting elements and the diffusing member or between the diffusing member and the second reflecting member and is formed in such a shape that a thickness of the sheet decreases as the distance from the optical axis of each of the light emitting elements increases.

3. The surface light source according to claim 2, wherein the phosphor layer has a plurality of conical portions each with a vertex that is a point on the optical axis of each of the light emitting elements, and a flat portion holding the conical portions and partially exposed between the conical portions.

4. The surface light source according to claim 1, wherein the phosphor layer is a set of distributed elements that are printed on a base layer so as to occupy a lower percentage of a circumference of a circle centered on the optical axis of each of the light emitting elements as the distance from the optical axis of each of the light emitting elements increases.

5. The surface light source according to claim 4, wherein the phosphor layer is composed of a plurality of dots, and diameters of the dots decrease as the distance from the optical axis of each of the light emitting elements increases.

6. The surface light source according to claim 4, wherein the phosphor layer is composed of a plurality of dots, and a density of the dots decreases as the distance from the optical axis of each of the light emitting elements increases.

7. The surface light source according to claim 4, wherein the first reflecting member is the base layer.

8. The surface light source according to claim 4, wherein the diffusing member is the base layer.

9. The surface light source according to claim 1, wherein the phosphor layer is disposed between the diffusing member and the second reflecting member.

10. The surface light source according to claim 1, wherein the second colored light is colored light that forms white light when mixed with the first colored light that passes through the phosphor layer.

11. The surface light source according to claim 10, wherein light emitted from the surface light source has a color temperature of 3000 K to 10000 K.

12. The surface light source according to claim 10, wherein the light emitting element is a light emitting diode that emits blue light with a dominant emission wavelength of 430 nm to 480 nm as the first colored light.

13. The surface light source according to claim 12, wherein the second colored light is yellow light with a dominant emission wavelength of 550 nm to 610 nm.

14. The surface light source according to claim 1, further comprising a lens, disposed to cover the light emitting element, for radially spreading the light emitted from the light emitting element.

15. A liquid crystal display apparatus comprising:
the surface light source according to claim 1; and
a liquid crystal panel that is irradiated from behind with light emitted from the surface light source and displays an image.
